(19) United States
(12) Patent Application Publication
(10) Pub. No.: US 2025/0175899 A1
(43) Pub. Date: May 29, 2025

(54) RESOURCE DETERMINATION FOR LOW POWER WAKE-UP SIGNAL

(71) Applicant: Intel Corporation, Santa Clara, CA (US)

(72) Inventors: Yingyang Li, Santa Clara, CA (US); Yi Wang, Santa Clara, CA (US); Gang Xiong, Portland, OR (US); Debdeep Chatterjee, San Jose, CA (US); Toufiqul Islam, Santa Clara, CA (US)

(21) Appl. No.: 18/839,864

(22) PCT Filed: Jul. 13, 2023
(86) PCT No.: PCT/US2023/070106

§ 371 Date: Aug. 20, 2024

Related U.S. Application Data
(60) Provisional application No. 63/389,272, filed on Jul. 14, 2022.
(60) Provisional application No. 63/389,294, filed on Jul. 14, 2022.
(60) Provisional application No. 63/411,541, filed on Sep. 29, 2022.
(60) Provisional application No. 63/484,952, filed on Feb. 14, 2023.
(60) Provisional application No. 63/484,979, filed on Feb. 14, 2023.
(60) Provisional application No. 63/411,496, filed on Sep. 29, 2022.

(51) Int. Cl. H04W 52/02

(52) U.S. Cl. CPC H04W 52/0235; H04W 52/0212

(57) ABSTRACT

Various embodiments herein provide techniques related to transmission of a wake-up signal (WUS) from a base station to a user equipment (UE). In embodiments, the WUS may be received by a wake-up receiver (WUR) of the UE. Based on reception of the WUS, a main receiver of the UE may exit from a deep-sleep state or an off state. Other embodiments may be described and/or claimed.

### CROSS REFERENCE TO RELATED APPLICATION

The present application claims priority to U.S. Provisional Patent Application No. 63/389,272, which was filed Jul. 14, 2022; U.S. Provisional Patent Application No. 63/389,294, which was filed Jul. 14, 2022; U.S. Provisional Patent Application No. 63/411,496, which was filed Sep. 29, 2022; U.S. Provisional Patent Application No. 63/411,541, which was filed Sep. 29, 2022; U.S. Provisional Patent Application No. 63/484,952, which was filed Feb. 14, 2023; and to U.S. Provisional Patent Application No. 63/484,979, which was filed Feb. 14, 2023.

### FIELD

Various embodiments generally may relate to the field of wireless communications. For example, some embodiments may relate to low power wake-up signaling in wireless communications.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a main receiver and a wake-up receiver, in accordance with various embodiments.

FIG. 2 illustrates an example of time resource determination for multiple wake-up signals (WUSs), in accordance with various embodiments.

FIG. 3 illustrates an example of frequency resource determination for multiple WUSs, in accordance with various embodiments.

FIG. 4 illustrates an example of an orthogonal frequency division multiplexed (OFDM) symbol divided into multiple WUS symbols, in accordance with various embodiments.

FIG. 5 illustrates an example of WUS symbol generation based on discrete Fourier transform spread OFDM (DFT-s-OFDM), in accordance with various embodiments.

FIG. 6 illustrates an example of WUS symbols transformed to K subcarriers, in accordance with various embodiments.

FIG. 7 illustrates an example of adding cyclic prefix (CP) and cyclic postfix for a group of WUS symbols, in accordance with various embodiments.

FIG. 8 illustrates an example of WUS symbols without gap in two OFDM symbols, in accordance with various embodiments.

FIG. 9 illustrates an example of WUS symbols without a gap in a first part of a low power (LP)-WUS, in accordance with various embodiments.

FIG. 10 illustrates an example of WUS symbols using NR OFDM symbols of subcarrier spacing (SCS) 480 kilohertz (kHz), in accordance with various embodiments.

FIG. 10 illustrates an example of WUS symbols using NR OFDM symbols of SCS 480 kHz without CP, in accordance with various embodiments.

FIG. 12 illustrates an example of a WUS symbol pattern with remaining samples, in accordance with various embodiments.

FIG. 13 illustrates an example wherein a LP-WUS starts from an OFDM symbol in a slot, in accordance with various embodiments.

FIG. 14 illustrates an example of a WUS time resource in one or more subframes, in accordance with various embodiments.

FIG. 15 illustrates an example of a WUS time resource in multiple slots, in accordance with various embodiments.

FIG. 16 illustrates an example of a WUS/channel with two parts, in accordance with various embodiments.

FIG. 17 illustrates an alternative example of a WUS/channel with two parts, in accordance with various embodiments.

FIG. 18 illustrates an example of a same bandwidth part (BWP) for a wake-up channel and other channels/signals, in accordance with various embodiments.

FIG. 19 illustrates an example of frequency division multiplexing (FDM) of multiple wake-up channels, in accordance with various embodiments.

FIG. 20 illustrates an example sequence related to part 1 for the FDMed wake-up channels, in accordance with various embodiments.

FIG. 21 schematically illustrates a wireless network in accordance with various embodiments.

FIG. 22 schematically illustrates components of a wireless network in accordance with various embodiments.

FIG. 23 is a block diagram illustrating components, according to some example embodiments, able to read instructions from a machine-readable or computer-readable medium (e.g., a non-transitory machine-readable storage medium) and perform any one or more of the methodologies discussed herein.

FIG. 24 illustrates a network in accordance with various embodiments.

FIG. 25 depicts an example technique related to embodiments herein.

FIG. 26 depicts another example technique related to embodiments herein.

FIG. 27 depicts another example technique related to embodiments herein.

FIG. 28 depicts another example technique related to embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Fifth Generation (5G) systems are designed and developed targeting for both mobile telephony and vertical use cases. Besides latency, reliability, and availability, user equipment (UE) energy efficiency may be considered to be critical to 5G. Legacy 5G devices (e.g., cell phones and the like) may have to be recharged per week or day, depending on individual's usage time. In general, 5G devices consume tens of milliwatts in the radio resource control (RRC) idle/inactive state, and hundreds of milliwatts in the RRC connected state. Designs to prolong battery life may be necessary to improve things like energy efficiency, user experience, etc.

Power consumption may depend on the configured length of wake-up periods, e.g., paging cycle. To meet the battery life requirements above, a long discontinuous reception (DRX) cycle may be used, resulting in high latency, which may not be suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors. As such, a long DRX cycle cannot meet the delay requirements. Therefore, it is necessary to reduce the power consumption with a reasonable latency.

In legacy LTE specifications, UEs may periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the main radio and a separate receiver of the UE that has the ability to monitor wake-up signal with ultra-low power consumption. The main receiver of the UE may work for data transmission and reception, and may be turned off or set to deep sleep unless it is turned on.

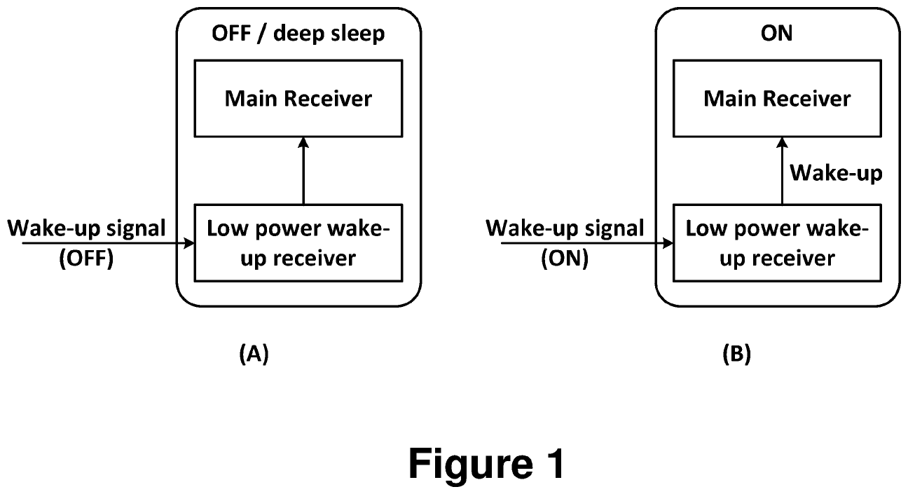

FIG. 1 illustrates one example for the use of main receiver and wake-up receiver. In the power saving state, if no wake-up signal is received by the wake-up receiver, the main receiver stays in OFF state for deep sleep. On the other hand, if a wake-up signal is received by the wake-up receiver, the wake-up receiver will trigger to turn on the main receiver. In the latter case, since main receiver is active, the wake-up receiver can be turned off.

The power consumption for monitoring wake-up signal depends on the wake-up signal design and the hardware module of the wake-up receiver used for signal detecting and processing. In this disclosure, the mechanism to determine the time, frequency and sequence resource for the wake-up signal/channel may be described with respect to various embodiments. Specifically, various embodiments herein provide techniques to determine the time, frequency and sequence resource for the wake-up signal/channel.

For the extremely low power consumption of the wake-up receiver (WUR), the WUR can only do non-coherent detection for the wake-up signal/channel (WUS), e.g., envelope detection. Modulation schemes such as ON-OFF Keying (OOK) or frequency shift keying (FSK) can be considered for WUS.

A WUS may include one part, where the WUS may be used to carry limited wake-up information. The WUS may be generated based on a sequence with pre-defined modulation symbols, e.g., OOK/FSK, or using channel coding for OOK/FSK symbols. An OOK/FSK symbol may consist of multiple samples in time. Alternatively, a WUS may include at least two parts. A first part may be for the WUR receiver to prepare for the detection, which is typically generated based on a sequence, and the second part which carries the wake-up information, which is typically using channel coding. The channel coding may be a spreading operation or repetition coding. The sequence information includes at least one of base sequence information, cyclic shift or phase rotation information of a base sequence and scrambling sequence information. A scrambling sequence may be applied to the first part. A scrambling sequence may be applied to the second part. A scrambling sequence may be applied to the samples in an OOK/FSK symbol. A scrambling sequence may be applied in unit of OOK symbol to the OOK/FSK symbols. Any one or multiple of the above scrambling sequence is denoted as sequence information in following embodiments.

To receive WUS, UE may need to know the time, frequency and sequence information for the WUS.

In one embodiment, at least one or more of time, frequency and sequence information for WUS is configured by gNB. The configuration can be carried by system information, e.g., remaining minimum system information (RMSI) or other system information, or configured by UE specific higher-layer signaling. For the case of UE specific higher-layer signaling configuration, the information can be stored by UE, even when UE enters RRC idle or inactive state.

In another option, for UE in RRC inactive state, at least one or more of time, frequency and sequence information for WUS can be configured in RRC_Release message.

If the information is not configured, the default value or pre-configuration can be used, or the value is derived based on a specific identifier (ID).

In one example, the time, frequency, sequence information and one or more specific ID for a WUS can be configured by gNB. The specific ID may be physical cell ID, tracking area ID or RAN area ID. In the LP-WUS configuration of the serving cell or the camped cell if UE is in idle mode, the above specific ID may not be included since it is already known to UE. On the other hand, if a LP-WUS is configured for a neighbor cell, the above specific ID may be included.

In one embodiment, at least one of time, frequency and sequence information for WUS is derived by UE, based on specific ID. The specific ID can be at least one of cell-specific ID, UE group ID, UE sub-group ID or UE ID such as tracking area ID or radio access network (RAN) area ID.

In one option, cell-specific ID can be physical cell ID (PCI or PCID). In another option, cell-specific ID can be N_{ID}⁽¹⁾ or N_{ID}⁽²⁾, where N_{ID}⁽¹⁾ or N_{ID}⁽²⁾ is the ID used for primary synchronization signal (PSS) and secondary synchronization signal (SSS) sequence generation as specified in the third generation partnership project (3GPP) technical specification (TS) 38.211. In another option, cell-specific ID can be a cell-group ID, e.g., an ID for cells within the same tracking area.

In one option, UE group ID or UE sub-group ID can be the group/sub-group ID for paging occasion (PO), which is determined by one or more of UE_ID, number of paging frames per cycle N, number of paging occasions for a paging frame Ns, number of subgroups per PO. In another option, UE group or sub-group ID is configured by gNB.

In one option, UE ID can be the UE_ID derived by a temporary mobile subscriber identity (TMSI) or International Mobile Subscriber Identity (IMSI) value, e.g., UE_ID=5G-S-TMSI mod 1024. In another option, UE ID can be a cellular radio network temporary identifier (C-RNTI). In another option, UE ID can be part of UE_ID or C-NTI. UE_ID, UE ID can be configured by gNB.

In one option, at least one or more of time, frequency and sequence information for WUS can be common to all cells, and remaining one or more of time, frequency and sequence information for WUS can be different for UEs. For example, sequence is common to all cells, i.e., independent of the specific ID, while the time and frequency location depends on the specific ID. For example, the starting physical resource block (PRB) of a WUS depends on a PRB-offset based on the cell-specific ID with reference to common PRB #0. For another example, the starting PRB of a WUS depends on a PRB-offset based on the UE group ID with reference to common PRB #0.

In another option, all of time, frequency and sequence information for WUS can be different for UEs.

For above options, the specific ID to determine sequence, time and frequency location can be different. For example, frequency location depends on cell-specific ID, and time location depends on UE group ID.

In one embodiment, at least one of time, frequency and sequence information for WUS is configured by gNB, and remaining one or more of time, frequency and sequence information for WUS is derived by UE, based on specific ID. For example, frequency resource for WUS is configured by gNB while sequence information is derived by cell ID. Alternatively, a set of at least one of time, frequency and sequence information for WUS is configured by gNB, and at least one or more of time, frequency and sequence information for WUS is derived based on the configured set and specific ID.

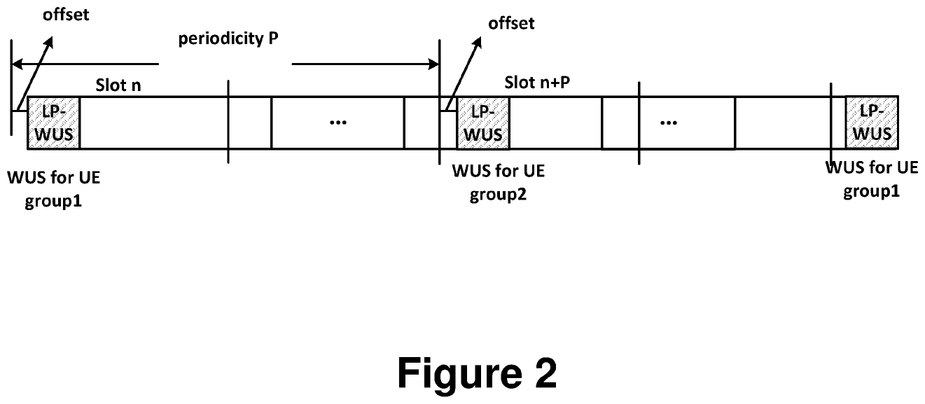

In one option, gNB can configure at least periodicity and offset for time domain resources for WUS. UE derives time domain resource for a WUS based on the specific ID and the configured time domain resources. FIG. 2 provides an example. It is noted that a 5G or beyond base station such as a gNodeB (gNB) may configure one or multiple LP-WUS occasions per period. Generally, a gNB will be used as an example for discussion herein for the sake of ease of description.

In one option, gNB can configure a set of sequences for multiple WUS. UE derives the sequence for a WUS based on the specific ID and configured set of sequences. For example, the specific ID for sequence for a WUS is UE group ID. 1^{st} sequence of the configured sequences is for 1^{st} UE group WUS, 2^{nd} sequence of the configured sequences is for 2^{nd} UE group WUS.

In one option, frequency region for frequency locations for WUS is configured by gNB. The reference point for frequency region configuration can be one of common PRB #0, reference point A, 1^{st} PRB of a synchronization signal (SS)/physical broadcast channel (PBCH), 1^{st} PRB of downlink (DL) initial BWP or active DL BWP or CORESET 0, 1^{st} PRB of a carrier. For example, with reference to common PRB #0, gNB configures the offset to indicate start of frequency region for WUS, and the number of RPBs for the frequency region.

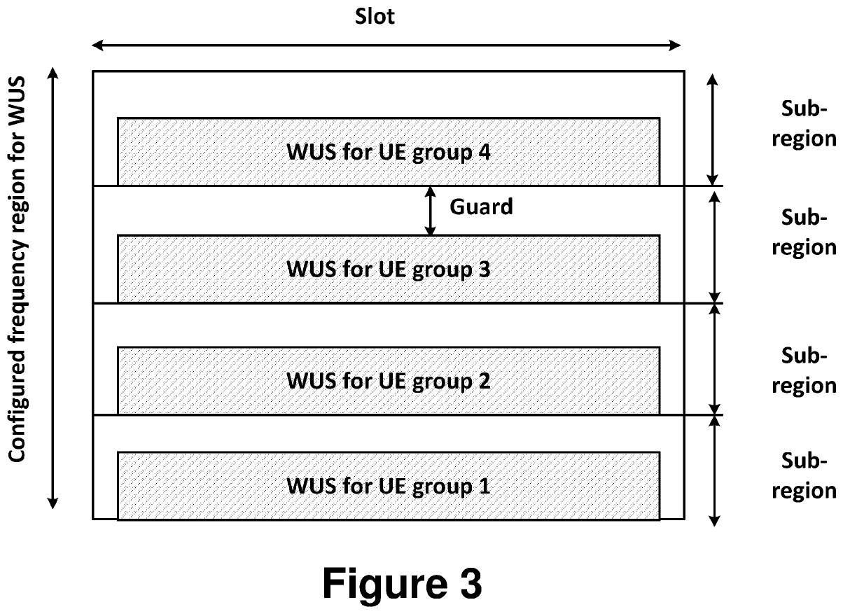

The frequency location for each WUS can be derived based on configured frequency region and the specific ID. For example shown in FIG. 3, there are 4 UE groups of a serving cell, and the specific ID for frequency location for WUS is UE group ID. The configured frequency region is divided into 4 sub-regions, and each sub-region is for frequency location for WUS for a UE group, e.g., WUS for 1^{st} UE group locates in 1^{st} sub-region, WUS for 2^{nd} UE group locates in 2^{nd} sub-region, etc. The bandwidth of each WUS can be pre-defined or configured by gNB. The frequency gap between each WUS can be pre-defined, configured by gNB, or derived by the sub-region size and bandwidth of a WUS.

In another option, the frequency location for WUS for a serving cell derives by initial DL BWP for the serving cell. Alternatively, the frequency location for WUS for a serving cell derives by PRBs for cell-specific SS/PBCH for the serving cell.

In one example, single frequency location for WUS for a serving cell is defined, e.g., derived by initial DL BWP or SS/PBCH. In another example, multiple frequency locations for multiple WUS for a serving cell is defined. For example, assuming K frequency locations for WUS can be supported for a serving cell, the bandwidth for a WUS is N PRBs, and initial BWP of a serving cell is M PRBs. Then, 1^{st} frequency location starts from 1^{st} PRB of initial DL BWP, and 2^{nd} frequency location starts from (N+Gn)-th PRB, wherein Gn is pre-defined or configured by gNB.

For embodiments above, a resource index i_{wus} for a WUS can be defined which is a function of one or more of time resource index iₜ, frequency resource index i_{f} and sequence resource index iₛ for a WUS. Based on the configured resource and/or a specific ID as provided in above embodiments, a UE can identify the resource index i_{wus} for the WUS to be received, and then, identify the time, frequency and sequence resource for the WUS.

For embodiments above, if a specific ID can be derived by at least one of time, frequency or sequence resource, the specific ID information is not further carried by the second part of a LP-WUS, e.g., the specific ID information is not part of payload of wake-up information carried by the second part. For example, the specific ID may be physical cell ID, tracking area ID or RAN area ID.

### LP-WUS Resource Determination in the Time Domain

As noted, for the extremely low power consumption of the WUR, the WUR may only perform non-coherent detection for the wake-up signal/channel, e.g., envelope detection. Correspondingly, the transmitter modulates the information using an ON symbol with a transmission power or an OFF symbol without transmission power. For example, the ON symbol or OFF symbol may directly indicate a bit 1 or 0, e.g., OOK. Other variances of OOK may be applicable too. For example, the Manchester coding may be used which indicates the information bit using the change of level of received energy between ON symbol and OFF symbol. In an ON symbol, gNB may transmit on multiple subcarriers in the frequency domain before performing inverse discrete fourier transform (IDFT) to convert to time-domain samples prior to transmission. On the other hand, gNB will not transmit anything on the subcarriers for an OFF symbol. For OOK, such modulation based on multiple subcarriers is also known as multi-carrier OOK (MC-OOK). In this disclosure, we use WUS symbol to indicate an ON symbol or an OFF symbol. In this disclosure, the terms wake-up signal/channel or low power wake-up signal (LP-WUS) may be used interchangeably. In some examples, an LP-WUS may be mapped to the WUS symbols in one or multiple OFDM symbols of main radio

### Numerology for Wake-Up Signal Same as Main Radio

In some embodiments, for a wake-up signal/channel, the WUS symbol may use the same SCS numerology as an OFDM symbol of other control/data channels/signals of a UE, e.g., same SCS as SS/PBCH, or same SCS as a control resource set (CORESET) 0 physical downlink control channel (PDCCH), or the SCS for initial or active bandwidth part (BWP), or SCS for WUS symbol may belong to a set of SCS numerologies supported by a serving cell or a frequency band for other new radio (NR) physical channels or signals. Specifically, the boundary of a WUS symbol may be aligned with the OFDM symbol of other control/data channels/signals, which can be beneficial considering the multiplexing of wake-up signal/channel with other channels/signals in the same channel bandwidth. With this scheme, in NR frequency range 1 (FR1), the SCS for the other control/data channels/signals is small which results in a long duration for the ON symbol or OFF symbol. In some examples, the OFDM symbol of other control/data channels/signals is also referred as the OFDM symbol of main radio in this disclosure.

In some implementations, a WUS symbol may only use a single subcarrier. The detection performance can be still good since the duration of the WUS symbol is long which provides high energy in the WUS symbol. On the other hand, if the detection performance is to be improved, an information bit can be spread to multiple bits and each bit is transmitted on a WUS symbol.

Additionally or alternatively, a WUS symbol may use multiple subcarriers. In an OFDM symbol, the transmission of wake-up signal/channel on multiple subcarriers may mitigate the impact of frequency selective fading. With this option, since more frequency resources are used for wake-up signal/channel, it is expected that small number of OFDM symbol is sufficient to carry an information. The bandwidth of WUS symbol can be smaller than the bandwidth of BWP in which the WUS symbol is located. In one example, the subcarriers used for WUS transmission are allocated within the initial or active DL BWP.

With this option, in one example, the multiple subcarriers of a WUS symbol are consecutive subcarriers. In another example, the multiple subcarriers of a WUS symbol are non-consecutive subcarriers. One special case for non-consecutive subcarriers is, the subcarriers used for a WUS symbol is with equal distance, e.g., WUS maps to every N-th subcarrier. For such case, in time domain, there are N repetitions. A WUS symbol can only take one or few repetitions of N repetitions. For example, with 15 KHz SCS, the duration of a OFDM symbol is 66.7 microseconds (us). If N=4, a WUS symbol maps to every 4th subcarrier within certain bandwidth, there are 4 repetitions within 66.7 μs after M-point IDFT. Then, only first M/N values of M-point IDFT output are selected as a WUS symbol. By this way, the duration of a OOK symbol is reduced compared with a OFDM symbol for other channels while same SCS is applied.

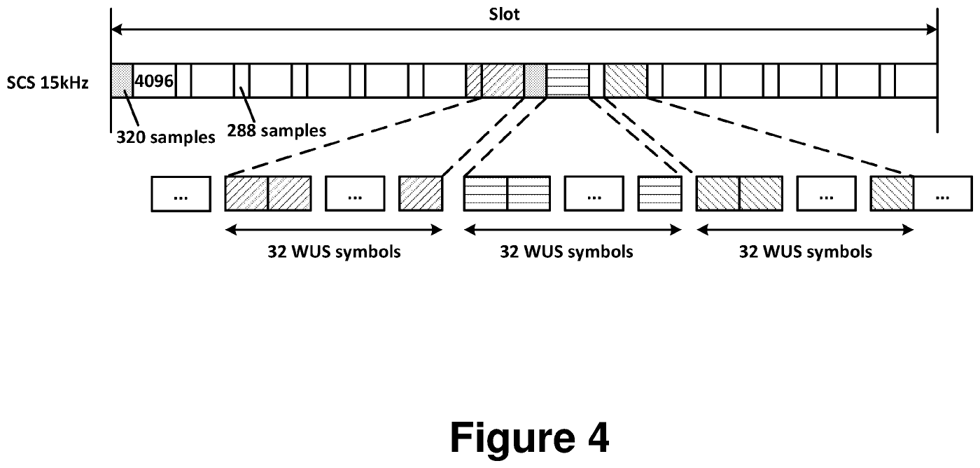

In some embodiments, an OFDM symbol can contain N WUS symbols. Denote the duration of the OFDM symbol as T, which is the same as the duration of a OFDM symbol for the control/data channels/signals of main radio (denoted as reference OFDM symbol), and the duration of each WUS symbol is T/N. In this embodiment, the cyclic prefix CP for the OFDM symbol is still added as done for the reference OFDM symbol in legacy NR. That is, the CP is the replica of ending part of the OFDM symbol. Due to the presence of the same length of CP, the boundary of the OFDM symbol carrying N WUS symbols can be aligned with the reference OFDM symbols. FIG. 4 illustrates one example that each OFDM symbol in a slot of SCS 15 kHz can carry 32 WUS symbols which is sequenced in time.

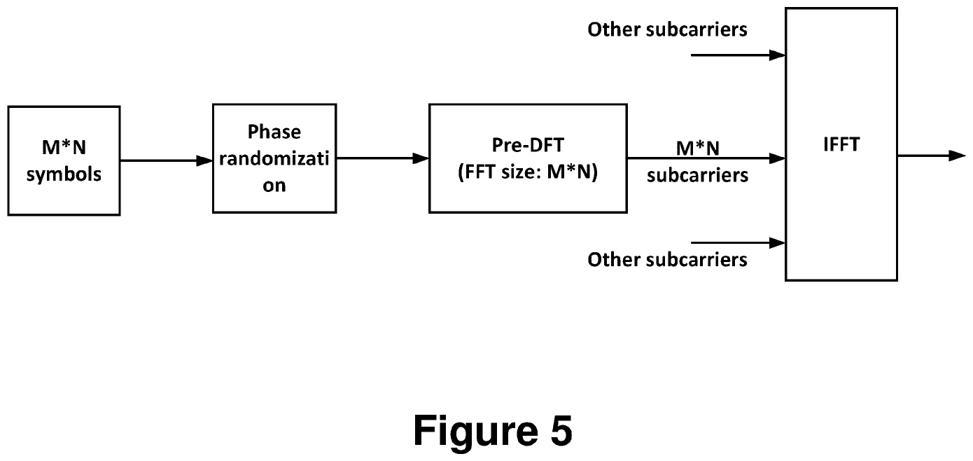

In some implementations, an OFDM symbol containing N WUS symbols can be generated by pre-discrete fourier transform (DFT) processing. FIG. 5 illustrates one example for the processing procedure. Assuming M·N subcarriers are occupied for the LP-WUS, each WUS symbol has M symbols before pre-DFT. Consequently, the N WUS symbols form a sequence of M·N symbols before pre-DFT. Each of the M symbols of a WUS symbol may have constant envelop of power 1, or the M symbols of a WUS symbol may be generated to approach a shape of signal, e.g., raised root cosine. The other shapes of signal are not precluded in this disclosure. Specifically, for an ON symbol, the M symbols generated by the shape of signal are transmitted. On the other hand, for an OFF symbol, M symbols of zero are transmitted. To avoid the increase of Peak-to-Average-Power-Ratio (PAPR), randomization can be applied to each WUS symbol before pre-DFT. In one example, the phase of each WUS symbol may be changed differently. In another example, a cyclic shift can be applied to each WUS symbol and the value of cyclic shift can be different for different WUS symbols.

In another example, a scrambling sequence can be applied to the WUS symbols of the LP-WUS. The scrambling sequence may be used to adjust the amplitude, the phase or the cyclic shifts of the WUS symbols. The scrambling sequence can be generated based on subframe index, slot index, OFDM symbol index, physical cell ID or virtual cell ID, tracking area ID, RAN area ID, cells, UE group ID or UE ID.

In some implementations, scrambling sequence for a first and second part of LP-WUS signal may be generated in accordance with OFDM symbol, slot index, subframe index, OOK sample index, physical cell ID or virtual cell ID, tracking area ID, RAN area ID, cells, UE group ID or UE ID. Further, scrambling sequence for the second part of LP-WUS signal may be generated in accordance with the sequence ID (e.g., orthogonal cover code ID and/or time/frequency resource index of the associated first part of LP-WUS signal).

Additionally or alternatively, an OFDM symbol containing N WUS symbols can be generated by transforming the targeted nonequispaced fast fourier transform (FFT) (collectively, NFFT) samples of the OFDM symbol to K subcarriers in frequency domain, then the K subcarriers are transformed back to time domain by inverse FFT (IFFT) operation.

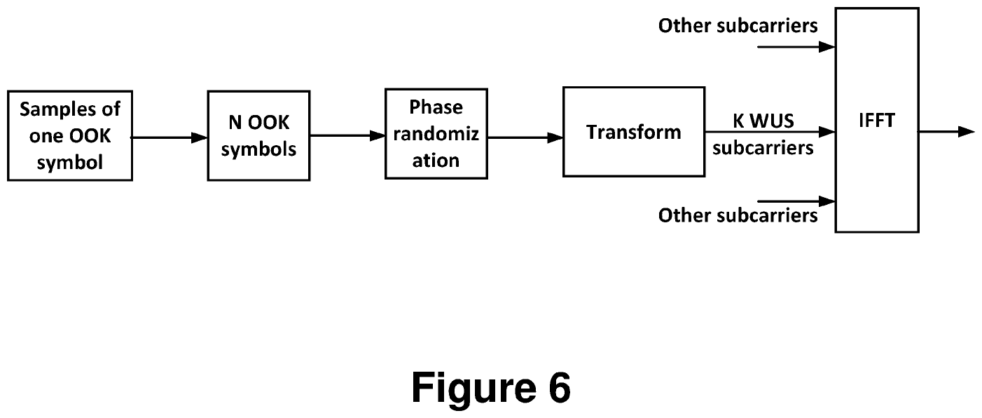

FIG. 6 illustrates one example for the processing procedure. In this scheme, each WUS symbol corresponds to NFFT/N samples in the targeted OFDM symbol. Each of the NFFT/N samples of a WUS symbol may have constant envelop of power 1, or the NFFT/N samples of a WUS symbol may be generated to approach a shape of signal, e.g., raised root cosine. The other shapes of signal are not precluded in this disclosure. Specifically, for an ON symbol, the NFFT/N samples generated by the shape of signal are transmitted. On the other hand, for an OFF symbol, NFFT/N samples of zero are transmitted. The value K may or may not be an integer times of value N. The above transform operation can be FFT operation but only K subcarriers after FFT are kept. Equivalently, denote the K columns of the FFT matrix as F, F is a NFFT×K matrix, the generated K subcarriers can be F^{H}S, where S is the targeted OFDM symbol. Alternatively, to normalize the power of signal, the generated K subcarriers can be (F^{H}F)⁻¹F^{H}S. To avoid the increase of Peak-to-Average-Power-Ratio (PAPR), randomization can be added to each WUS symbol before transform. In one example, the phase of each WUS symbol may be changed differently. In another example, a cyclic shift can be applied to each WUS symbol and the value of cyclic shift can be different for different WUS symbols.

In another example, a scrambling sequence can be applied to the WUS symbols of the LP-WUS. The scrambling sequence may be used to adjust the amplitude, the phase or the cyclic shifts of the WUS symbols. The scrambling sequence can be generated based on subframe index, slot index, OFDM symbol index, physical cell ID or virtual cell ID, tracking area ID, RAN area ID, cells, UE group ID or UE ID.

In any of the aforementioned examples, the number of WUS symbols in an OFDM symbol, e.g., value N can be predefined, or configured by high layer signaling. The value N can be determined by the SCS of reference OFDM symbol. For example, there can be one-to-one mapping between value N and the SCS of the reference OFDM symbol. Alternatively, if multiple values of N are supported for a SCS of reference OFDM symbol, the value N can be configured by high layer from the set of supported N values for the SCS of reference OFDM symbol.

In the NR frame structure, there is one OFDM symbol with about 0.52 μs longer CP duration. For example, for SCS 15 kHz as shown in FIG. 4, there is a longer CP for every 7 OFDM symbols. Since N WUS symbols are carried in the OFDM symbol except CP part, the WUS receiver has to adjust the timing of WUS symbols for each OFDM with longer CP which causes increased complexity.

In some embodiments, the CP and cyclic postfix are added to make a fixed gap between every N WUS symbols. For a group of N WUS symbols which corresponds to an ODFM symbol in main radio, after adding CP and cyclic postfix, the start time and end time are aligned with an OFDM symbol with CP of the main radio. The cyclic postfix is generated by repeating the beginning part of an OFDM symbol and is appended after the end of the OFDM symbol.

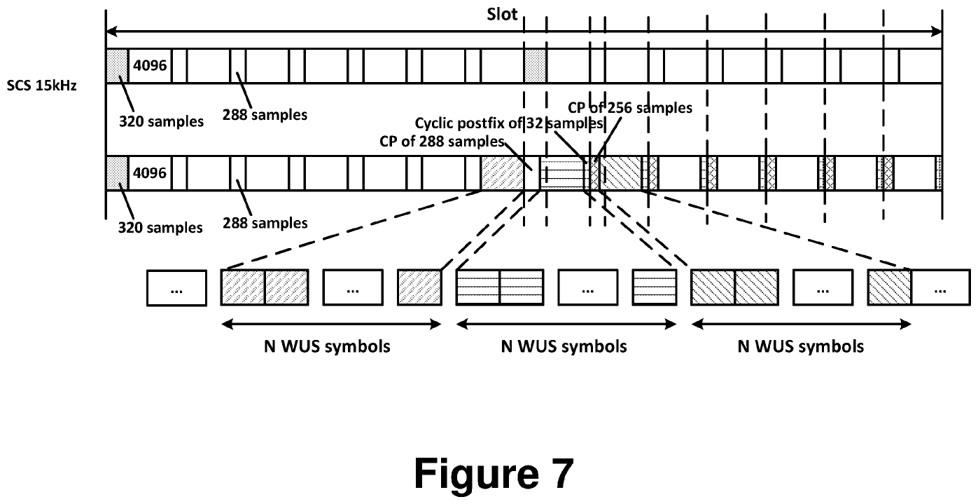

FIG. 7 illustrates one example on adding CP and cyclic postfix for the N WUS symbols corresponding to one OFDM symbol with SCS 15 kHz of main radio. There is no change on the existing OFDM symbol structure for the first 7 OFDM symbols in a slot. That is, CP of 320 samples is added for the first OFDM symbol and CP of 288 samples are added to each of the next 6 OFDM symbols. No cyclic postfix is added for the first 7 OFDM symbols. The CP of 320 samples for the 8th OFDM symbol is split into a CP of 288 samples and a cyclic postfix of 32 samples. The CP of 288 samples of the remaining OFDM symbols in the slot is divided into a CP of 256 samples and a cyclic postfix of 32 samples. Note: For the last 7 OFDM symbols in the slot, the timing of the effective OFDM symbol is shifted by 32 samples comparing to the effective OFDM of main radio, however it doesn't cause any inter-subcarrier interference (ICI) thanks to the CP and cyclic postfix. With the new CP and cyclic postfix structure, equal gap of 288 samples is achieved for any two adjacent OFDM symbols in the slot.

The above scheme to split the CP in the frame structure of main radio may be extended to the multiple consecutive slots. The different lengths of CP and cyclic postfix can be used in the multiple slots so that the gap is fixed between every two adjacent groups of N WUS symbols. In one example, to have fixed gap of 288 samples, the length of CP and cyclic postfix in 6 consecutive slots can be determined by the following Table 1.

TABLE 1
Length of CP and cyclic postfix

| | OFDM symbol | CP | Length of |
|---|---|---|---|
| Slot | index | length | cyclic postfix |
| 0 | 0 | 320 | 0 |
| | 1-6 | 288 | 0 |
| | 7 | 288 | 32 |
| | 8-13 | 256 | 32 |
| 1 | 0 | 256 | 64 |
| | 1-6 | 224 | 64 |
| | 7 | 224 | 96 |
| | 8-13 | 192 | 96 |
| 2 | 0 | 192 | 128 |
| | 1-6 | 160 | 128 |
| | 7 | 160 | 160 |
| | 8-13 | 128 | 160 |
| 3 | 0 | 128 | 192 |
| | 1-6 | 96 | 192 |
| | 7 | 96 | 224 |
| | 8-13 | 64 | 224 |
| 4 | 0 | 64 | 256 |
| | 1-6 | 32 | 256 |
| | 7 | 32 | 288 |
| | 8-13 | 0 | 288 |
| 5 | 0 | 0 | 320 |
| | 1-6 | N.A. | N.A. |
| | 7 | N.A. | N.A. |
| | 8-13 | N.A. | N.A. |

Additionally or alternatively, if the WUS symbols are to be mapped to two consecutive OFDM symbols of main radio, the CP or cyclic postfix can be respectively added to the first and second OFDM symbol so that all 2N WUS symbols are generated without gap. The receiver for LP-WUS may be simplified.

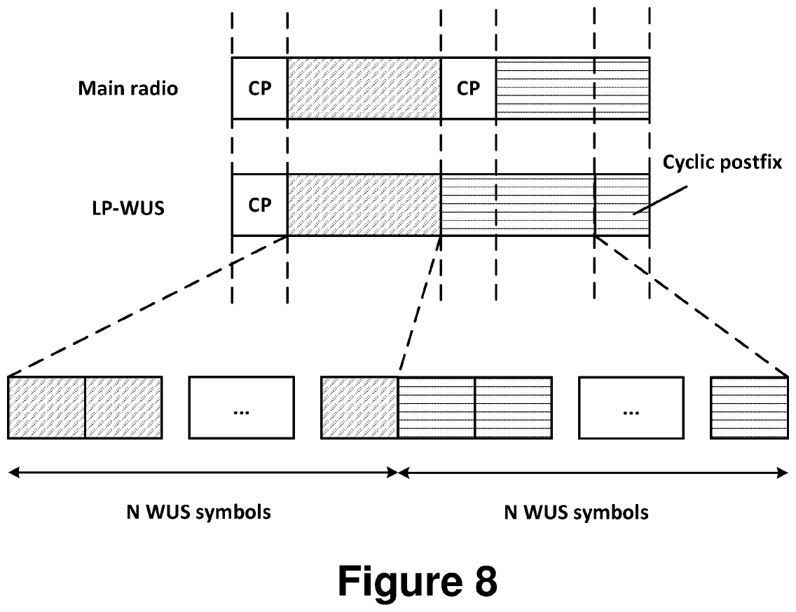

FIG. 8 illustrates one example on the generation of 2N WUS symbols without gap in two OFDM symbols of main radio. The first OFDM symbol is not changed, e.g., CP length may still be added without cyclic postfix as main radio. On the other hand, the CP for the second OFDM symbol is replaced by a cyclic postfix with same length as the CP. For example, if the two OFDM symbols are OFDM symbols with index 0 & 1 in a slot, the CP length is 320 samples and the cyclic postfix is 288 samples.

In some embodiments, for a LP-WUS made up of two parts, assuming the first part is mapped to two consecutive OFDM symbols in main radio, the scheme in the previous embodiment can be used to generate the WUS symbols of part 1, while other embodiments can be used to generate WUS symbols of part 2. In one example, the part 1 may carry a preamble which includes a sequence of WUR symbols while the part 2 is a message part. With this scheme, the detection for at least the part 1 can be simplified. Note: the gap between part 1 and part 2 is the duration of a cyclic postfix plus a CP.

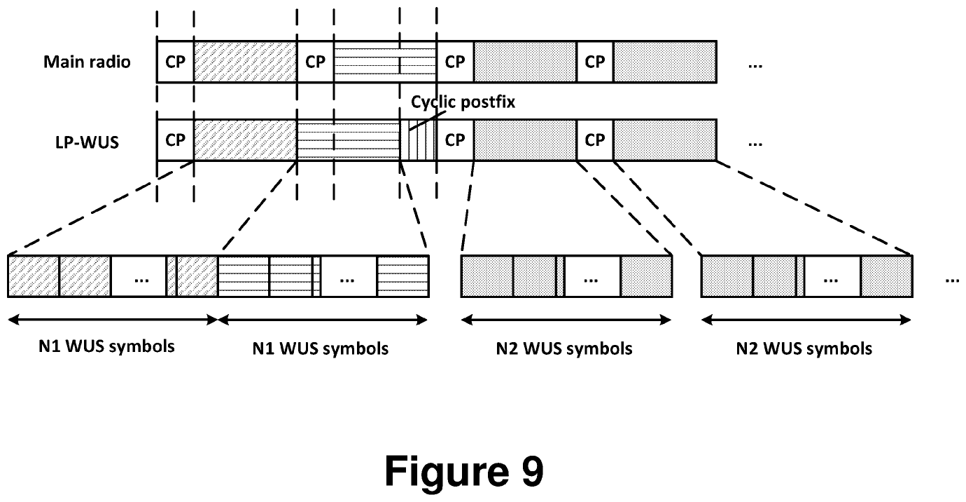

FIG. 9 illustrates one example on mapping of WUS symbols for the two parts of a LP-WUS. Assuming one OFDM symbol in main radio is divided into N1 WUS symbols of part 1, there is no gap for 2N1 WUS symbols in part 1. Further, assuming one OFDM symbol in main radio is divided into N2 WUS symbols of part 2, CP and/or cyclic postfix are still added for each group of N2 WUS symbols in part 2. For example, assuming the length of cyclic postfix and CP are both 288 samples, the gap between WUS symbols in part 1 and part 2 is 276 samples.

Numerology for Wake-Up Signal Different from Main Radio

In some embodiments, the wake-up signal/channel may use a different SCS numerology than the other channels/signals in the active BWP of a UE or SCS for WUS symbol can be value other than a set of SCS numerologies supported by a serving cell or a frequency band for other NR physical channels or signals. For a UE in IDLE/INACTIVE state, the above active BWP of the UE is the initial DL BWP. On the other hand, for a UE in CONNECTED state, the above active BWP can be a configured BWP which activated by RRC signaling or a downlink control information (DCI) format. Since the information can only be carried by the WUS symbols in time domain, enforcing the same SCS numerology between WUS symbol and the OFDM symbol for other channel/signals may result in limitation on the number of WUS symbols that can be transmitted in a period. For example, For frequency range 1 (FR1) with SCS 15 kHz, a slot may include 14 OFDM symbols which limit the number of WUS symbols to 14 in one millisecond. If spreading is considered for performance improvement, the amount of information can be indicated in the slot is significantly reduced. For example, denote the SCS of wake-up signal/channel as μ and the SCS of other channels/signals in the active BWP as μₘ, u≠μₘ for certain frequency band, e.g., u>μₘ for FR1 and FR2-1. The proper SCS μ for the WUS symbol may be determined by the channel delay spread. That is, the duration of a WUS symbol should be much longer than the delay spread so that its impact to the detection of ON symbol or OFF symbol is neglectable or tolerable.

In one example, in a cell on FR1, the UE may be configured with a BWP of 15 kHz SCS for the control/data transmission. Further, the UE may be configured to detect a wake-up signal with SCS 480 kHz. An OFDM symbol of 15 kHz can be divided into 32 WUS symbols with 480 kHz. The duration of a WUS symbol is about 2.2 μs.

In another example, in a cell on FR1, the UE may be configured with a BWP of 30 kHz SCS for the control/data transmission. Further, the UE may be configured to detect a wake-up signal with SCS 240 kHz. An OFDM symbol of 30 kHz can be divided into 8 WUS symbol with 240 kHz. The duration of a WUS symbol is about 4.4 μs.

In some embodiments, the SCS for a WUS symbol is configurable. Alternatively, the combination of the SCS for a WUS symbol and the SCS for other channels/signals of a UE is configurable, or pre-defined according to frequency band for the WUS transmission or the transmission of associated data/control channel.

In some embodiments, a WUS symbol with SCS y is mapped to a part of an OFDM symbol with SCS μₘ in NR. Specifically, the duration of an OFDM symbol with SCS μₘ of the other channels/signals in the active BWP (denoted as reference OFDM symbol) is equally divided into N WUS symbols, N=2^{μ-μ}^{ₘ}. The boundary of an OFDM symbol with SCS μₘ is aligned with the boundary of a WUS symbol with SCS μ. With this option, there is one WUS symbol with about 0.52 μs longer duration in every 0.5 ms.

In some implementations, the duration of a reference OFDM symbol with CP is equally divided into N WUS symbols with CP, N=2^{μ-μ}^{ₘ}.

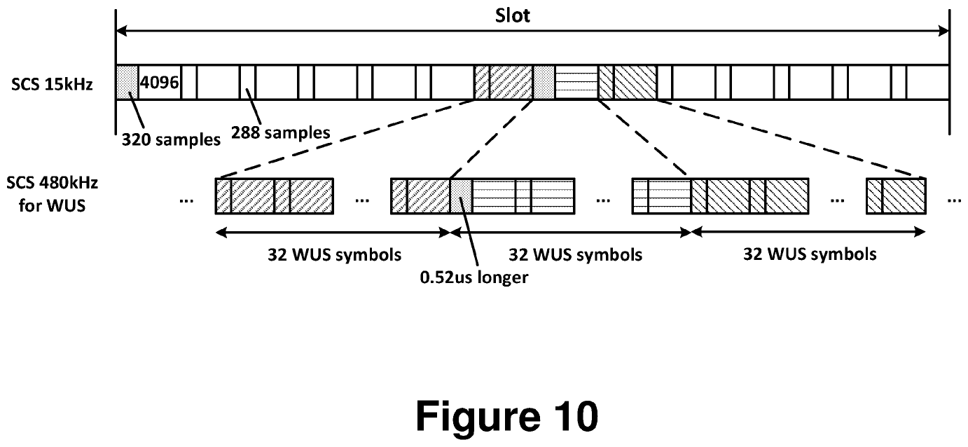

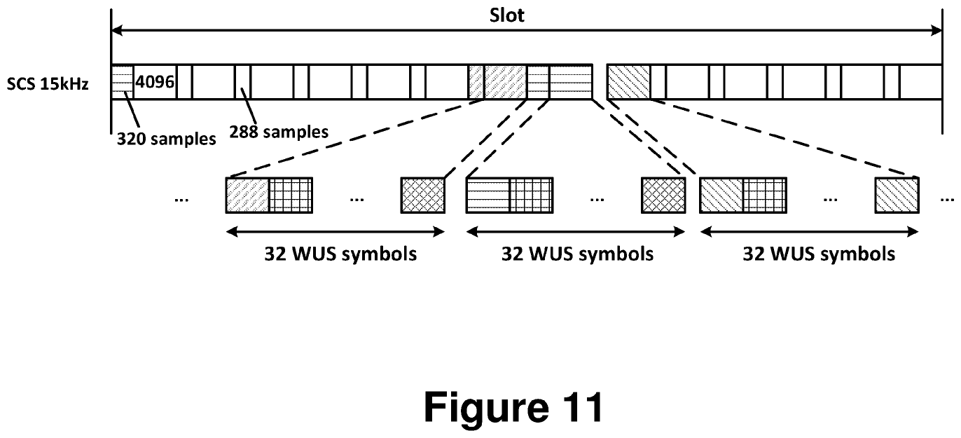

FIG. 10 illustrates one example for the mapping of WUS symbols in a slot of SCS 15 kHz. It is assumed that SCS 480 kHz is used for the wake-up signal. Since there is one OFDM symbol with relative longer CP (320 samples) in every 7 OFDM symbols of 15 kHz, there is one WUS symbol have about 0.52 μs longer duration. Note: this periodically occurring WUS symbol with longer duration may impact the detection at the WUR. On the other hand, since WUR normally uses a rough synchronization, the impact of the extra 0.52 μs may be marginal.

Additionally or alternatively, the duration of a reference OFDM symbol without CP is divided into N WUS symbols without CP, N=2^{μ-μ}^{ₘ}. Then, CP for a WUS OFDM symbol is added as done for the reference OFDM symbol in existing NR. That is, the CP is the replica of ending part of the OFDM symbol. Due to the presence of same length of CP, the boundary of the OFDM symbol carrying N WUS symbols can be aligned with the OFDM symbols of main radio.

FIG. 11 illustrates one example for the mapping of WUS symbols in a slot of SCS 15 kHz. It is assumed that SCS 480 kHz is used for the wake-up signal. Comparing FIG. 4, the 32 WUS symbols in the duration of an reference OFDM symbol are separately generated in FIG. 11. On the other hand, in FIG. 4, the 32 WUS symbols are generated by a transform operation, so the 32 WUS symbols has mutual impacts.

Additionally or alternatively, one or more consecutive subframes or slots of main radio can be divided into multiple WUS symbols with same duration for a wake-up signal/channel. Specifically, the CP length can have the same length for all WUS symbols. By this way, the detection algorithm for the wake-up signal/channel may be simplified which is good for further power saving.

In some implementations, a slot or subframe may be divided into an integer number of WUS symbols with same CP length. For example, the CP length may be ¼ of the OFDM symbol, which corresponds to extended CP for SCS 60 kHz in NR. In a slot or subframe with SCS 15 kHz, it is divided into 48 OFDM symbols with SCS 60 kHz and extended CP. If SCS 480 kHz is used for wake-up signal/channel, the total number of WUS symbols in a slot or subframe of 15 kHz is 384.

Additionally or alternatively, the duration of Ns subframes (each subframe has 1 ms) may be divided into an integer number of WUS symbols with same CP length, e.g., Ns=5. The number of WUS symbols in the 5 subframes is 64·2^{μ}. If SCS μ=480 kHz is used for wake-up signal/channel, the total number of WUS symbols in 5 subframes are 2048.

Additionally or alternatively, the WUS symbol may be an OFDM symbol with SCS u without CP. For example, a subframe can be divided into 15·2^{μ} WUS symbols.

Additionally or alternatively, each WUS symbol has equal CP length. There may exist remaining samples which cannot form a WUS symbol in the one or more consecutive subframes or slots after a number of WUS symbols with equal CP length are allocated. Such remaining samples may be located at the beginning or ending of the one or more consecutive subframes or slots. gNB may not transmit any signal on the remaining samples so that it effectively provides a time gap. Alternatively, gNB may still transmit on the remaining symbols, e.g., using extended CP. Then, it is up to UE implementation how to use the signals on the remaining samples. For example, the remaining samples can be used for automatic gain control (AGC) adjustment.

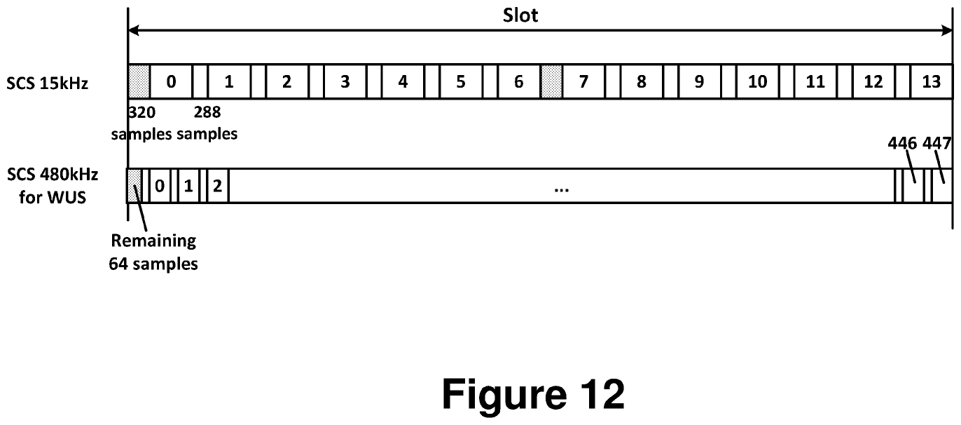

FIG. 12 illustrates one example for a pattern of allocated WUS symbols with remaining samples that is not enough for a WUS symbol. A subframe may have 15·4096 samples for SCS 15 kHz. These 15·4096 samples can be divided into 14·32=448 WUS symbols with SCS 480 kHz and CP length of 9 samples, there are still remaining 64 samples which are not allocated to any WUS symbol.

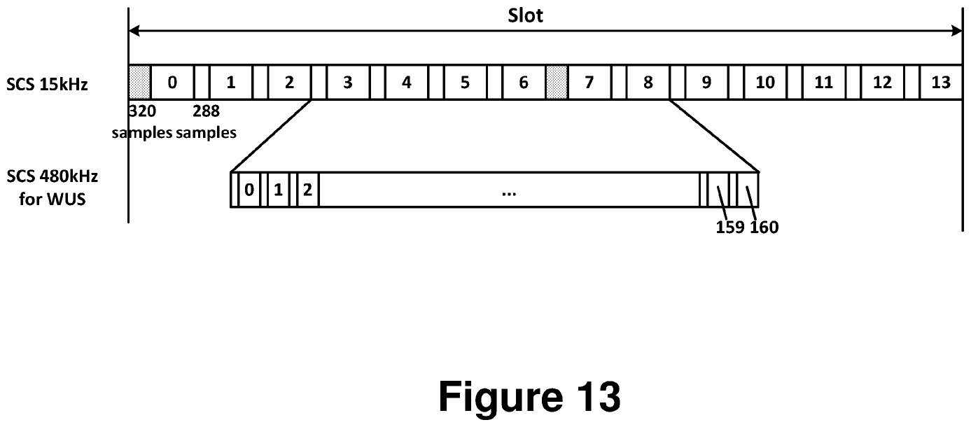

FIG. 13 illustrates one example for a pattern of allocated WUS symbols starting from an OFDM symbol in the slot of main radio. The LP-WUS may not last until end of the slot. In FIG. 13, it assumes the LP-WUS are mapped to OFDM symbol 3-8 of main radio. Therefore, there are 160 WUS symbols in the LP-WUS. Each WUS symbol uses SCS 480 kHz and CP length of 9 samples.

### Channel Structure in Time

The candidate wake-up signal/channel occasion may appear periodically or aperiodically in time. Within an occasion, a wake-up signal/channel may be mapped to consecutive OFDM symbols. The total duration of the wake-up signal/channel is dependent on the payload size that is carried by the wake-up signal/channel.

To determine the start of a wake-up signal/channel, the slot/subframe/frame-level offset and symbol-level offset to a reference point in time domain should be defined. The symbol or slot-level offset may be indicated in unit of WUS symbol (with SCS μ). Alternatively, the symbol or slot-level offset of the wake-up signal/channel may be indicated in unit of OFDM symbol with SCS μₘ for other channel/signals in the BWP of the UE, e.g., μₘ is SCS for SS/PBCH. Note: the SCS μ for a WUS symbol may be same as SCS μₘ of main radio.

Further, the slot/subframe/frame-level offset and periodicity of WUS can be configured by higher layers via NR remaining minimum system information (RMSI), NR other system information (OSI) or dedicated radio resource control (RRC) signalling.

In some embodiments, the start of a wake-up signal/channel is defined relative to the start of a subframe or frame or slot. In one example, the frame or subframe or slot, e.g., reference frame or sub-frame or slot, which is used to identify the starting position of LP WUS can be obtained at an offset before the PO. In some implementations, the offset can be measured in frames, sub-frames, slots, or symbols. In another example, first occasion of the LP WUS is obtained at a symbol offset from the start of the reference frame or sub-frame or slot.

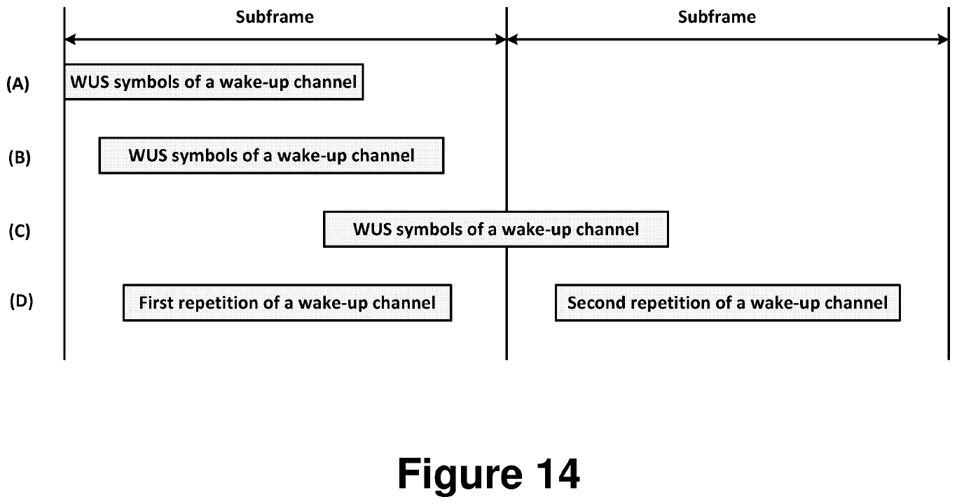

In some implementations, a wake-up signal/channel may be defined from the start of a subframe (e.g., symbol-level offset to a subframe is zero), as is shown in FIG. 14 at (A). Additionally or alternatively, a wake-up signal/channel may be defined to start in a subframe with a non-zero symbol-level offset, as is shown in FIG. 14 at (B).

In some implementations, a wake-up signal/channel may be confined with a subframe as shown in FIG. 14 at (A) or (B). Additionally or alternatively, a wake-up signal/channel can cross the boundary of one or more subframes as shown in FIG. 14 at (C), which is especially useful if a long duration has to be used to transmit the wake-up information subjected a target reliability.

In some implementations, a wake-up signal/channel may be transmitted with N repetitions. N can be predefined or configured by high layer. N repetitions can be consecutive or non-consecutive in time domain, e.g., with or without symbol-level gap between adjacent repetitions. This is beneficial to improve the link level performance. For example, the start WUS symbol and the number of WUS symbols in a subframe can be same for all repetitions, which is similar to PDSCH repetition type A, as shown in FIG. 14 at (D).

In some embodiments, the start of a wake-up signal/channel is defined relative to the start of a slot with WUS SCS p. Alternatively, the start of a wake-up signal/channel is defined relative to the start of a slot of the other channel/signal SCS μₘ in the BWP of UE. Since a slot may only include a limited number of WUS symbols, a wake-up signal/channel usually crosses multiple slots.

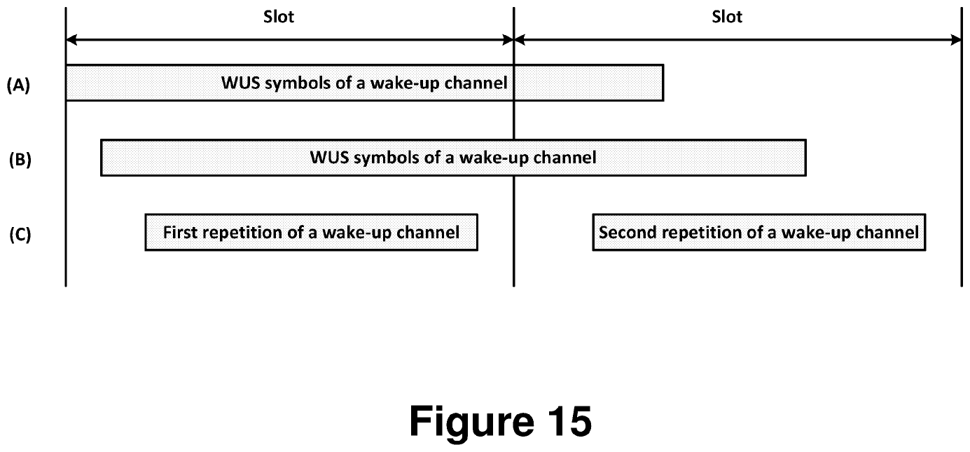

In some implementations, a wake-up signal/channel may be defined to start from the start of a slot, as is shown in FIG. 15 at (A). Additionally or alternatively, a wake-up signal/channel may be defined to start in a slot with a non-zero symbol-level offset, as is shown in FIG. 15 at (B).

In some implementations, a wake-up signal/channel may be transmitted with N repetitions. N can be predefined or configured by high layer. This is beneficial to improve the link performance. For example, in FIG. 15 at ©, a repetition is confined with a slot and the start WUS symbol and the number of WUS symbols in a slot can be same for all repetitions, which is similar to PDSCH repetition type A. Further, it is possible that a wake-up signal/channel can have multiple repetitions and each repetition occupies multiple consecutive WUS symbols in multiple slots.

In some embodiments, a wake-up signal/channel may include one part, where the WUS may be used to carry limited wake-up information. The WUS may be generated based on a sequence or using channel coding.

In some embodiments, a wake-up signal/channel may include at least two parts. A first part may be for the WUR receiver to prepare for the detection of the second part which carries the wake-up information.

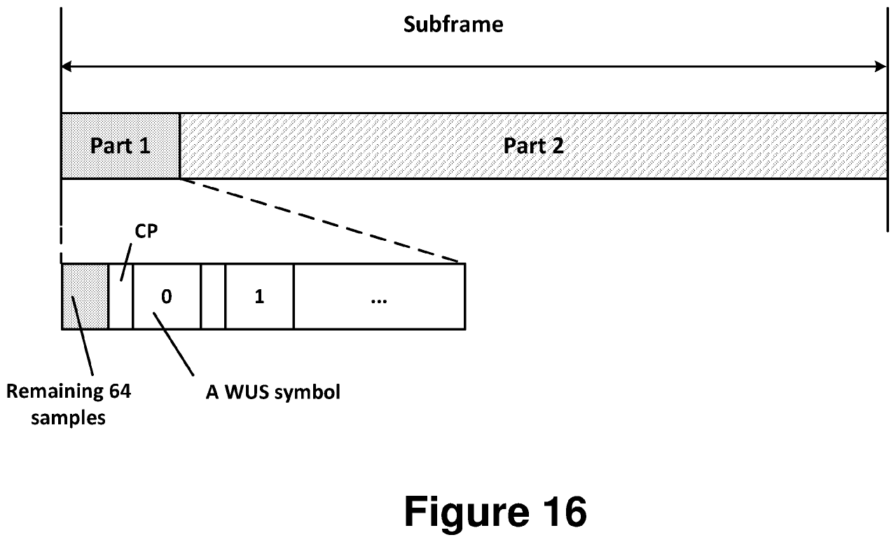

In some implementations, the above first part of the wake-up signal/channel may carry a known signal or a signal which is up to implementation. The first part is one or multiple OFDM symbols with SCS μ_{AGC}. μ_{AGC} may be same as or different from y for WUS symbol. μ_{AGC} may be same as or different from μₘ for other channels/signals in the BWP of the UE. The first part may be generated in the same way as generating other WUS symbols of LP-WUS. In this option, a sequence for the WUS symbols in the first part may be predefined or configured. Alternatively, it is up to gNB implementation to transmit a proper signal in the first part, consequently, UE can only perform energy detection in the first part. If there are remaining samples after the allocation of WUS symbols for wake-up signal/channel, the remaining samples can be merged to the first part and can be used for AGC, which is an option shown in FIG. 12. In FIG. 16, it assumes the first part can include multiple WUS symbols and the remaining samples after the allocation of WUS symbols in the subframe, if any.

In this option, the WUR receiver may perform AGC using the first part. The first part may also help time/frequency synchronization given that the requirement for synchronization of the wake-up signal detection is low. If the first part is detected with an energy or power level higher than a threshold, the UE may further detect the second part. In other words, the first part is an indicator on whether the second part is transmitted or not. Further, the first part may also carry one or more information bits.

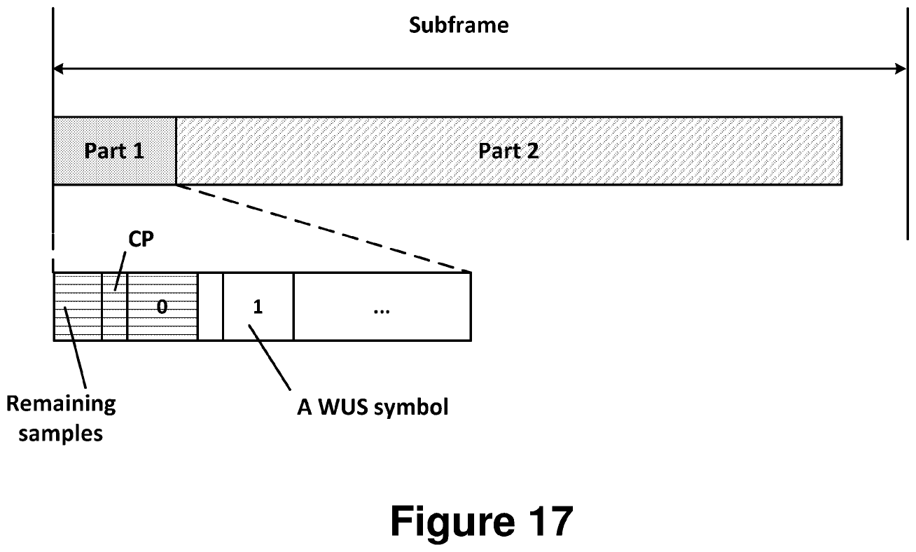

Additionally or alternatively, the first part of a wake-up signal/channel include an empty interval in the beginning. The remaining time in the first part is used for AGC, or time/frequency synchronization, or indication for the detection of the second part, or carrying one or more information bits. In a cellular network, the signal from adjacent cells may come to the UE with a delay which may impact the wake-up signal/channel detection by the UE. The empty interval in the first part serves as a guard time to protect the wake-up signal/channel from adjacent cell interference. Specifically, if there are remaining samples after the allocation of WUS symbols for wake-up signal/channel, the remaining samples can be merged to empty interval part as guard time, which is another option shown in FIG. 12. In FIG. 17, the first part with duration determined by the multiple WUS symbols and the remaining samples after the allocation of WUS symbols in the subframe, if any. Note: the empty interval may only include the remaining samples or include both the remaining samples and one or more WUS symbols.

### LP-WUS Design in the Frequency Domain

The power consumption for monitoring wake-up signal depends on the wake-up signal design and the hardware module of the wake-up receiver used for signal detecting and processing. Embodiments herein relate to example designs for the wake-up signal/channel are presented. In particular, embodiments in this section may relate to one or more of the following:
Bandwidth part (BWP) configuration considering a wake-up signal/channel; and/or
Frequency division multiplex (FDM) multiplexing of multiple wake-up signals/channels

For the extremely low power consumption of the wake-up receiver (WUR), the WUR may only do non-coherent detection for the wake-up signal/channel, e.g., envelope detection. Correspondingly, the transmitter may modulate the information using an ON symbol with a transmission power or an OFF symbol without transmission power. For example, the ON symbol or OFF symbol may directly indicate a bit 1 or 0, i.e., ON-OFF Keying (OOK). Other variances of OOK may be applicable too. For example, the Manchester coding may be used which indicates the information bit using the change of level of received energy between ON symbol and OFF symbol. In an ON symbol, gNB may transmit on multiple subcarriers. On the other hand, gNB will not transmit anything on the subcarriers for an OFF symbol. For OOK, such modulation based on multiple subcarriers is also known as multi-carrier OOK (MC-OOK). In discussion of embodiments in this section, a WUS symbol may be used to indicate an ON symbol or an OFF symbol.

For a wake-up signal/channel, each WUS symbol may be mapped to N consecutive subcarriers with SCS u. The value N may be predefined or configured by high layer signaling. The center subcarrier of the N subcarriers may be the direct current hence is not used to carry a signal. Alternatively, each of the N subcarriers may carry a signal. The transmission of wake-up signal/channel on multiple subcarriers may mitigate the impact of frequency selective fading. On the other hand, it is not necessary to map a wake-up signal/channel in the full carrier bandwidth or bandwidth of bandwidth part (BWP).

In one example, if the WUS symbol of the wake-up signal/channel use 8 consecutive subcarriers with SCS 480 kHz, the occupied BW of the wake-up signal/channel is 3.84 MHz, which is about 22 PRBs for SCS 15 kHz. In this example, a wake-up signal/channel is limited to 5 MHz BW.

In another example, if the WUS symbol of the wake-up signal/channel use 7 consecutive subcarriers with SCS 480 kHz, the occupied BW of the wake-up signal/channel is 3.36 MHz, which is about 19 PRBs for SCS 15 kHz, which is within the BW of SS/PBCH. In this example, the UE may use the filter for SS/PBCH for the detection of a wake-up signal/channel.

In one embodiment, a wake-up signal/channel for a UE can be configured in the same initial or active BWP for other channels/signals of the UE. Note: though the same BWP is assumed, the SCS u of the wake-up signal/channel may be still different from the μₘ of the BWP. Specifically, the wakeup signal/channel may be configured in the initial DL BWP configured in SIB1 which can be used by UE in IDLE state.

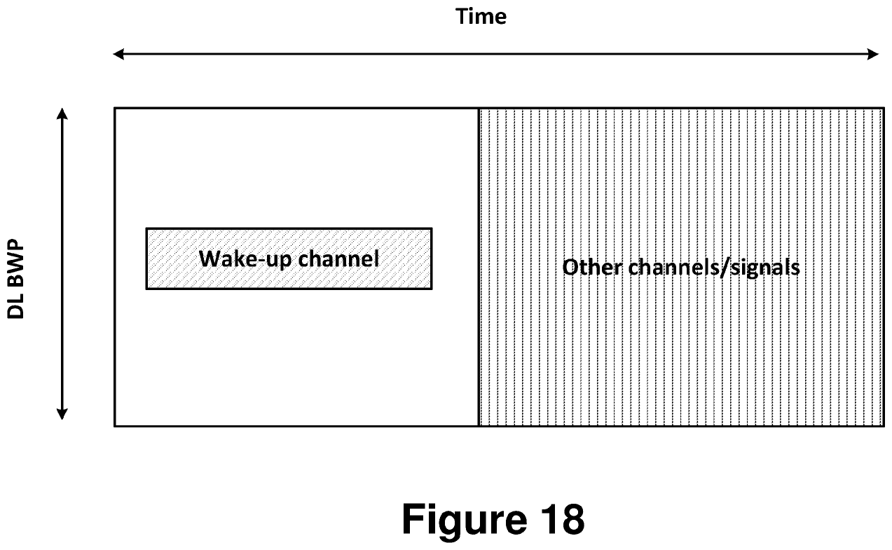

FIG. 18 illustrates one example that the wake-up signal/channel can be configured in the same active BWP as other channels/signals.

In one embodiment, a wake-up signal/channel for a UE can be configured in a BWP which is same or different from the initial or active BWP for other channels/signals of the UE. Note: Since the WUR receiver and main receiver are separate, it may not be a problem if the BWP configuration is different for the WUR receiver and main receiver.

In one option, the BWP with configured wake-up signal/channel may be still one of the multiple BWPs configured for a UE. For example, the BWP with configured wake-up signal/channel is the initial DL BWP, or default DL BWP, or the first activated DL BWP indicated by firstActiveDownlinkBWP-Id.

In another option, a BWP can be dedicatedly configured for wake-up signal/channel transmission, which is not used for the transmission of other channels/signals. This BWP may or may not counted as one RRC configured BWP for the UE. This BWP may be configured by SIB signaling or by dedicated higher layer signaling. For a UE in Idle/inactive mode, the configuration may be used from the dedicated RRC signaling received by the UE when it was last in RRC_CONNECTED mode.

In an embodiment, for any of the above BWP options, the bandwidth of BWP for wake-up signal/channel is same as the bandwidth of the wake-up signal/channel. Alternatively, the bandwidth of BWP for wake-up signal/channel can be larger than the bandwidth of the wake-up signal/channel.

In an embodiment, for any of the above BWP options, the location of the wake-up signal/channel within a BWP may be defined by the location of the center subcarrier of the wake-up signal/channel. In another embodiment, the location may be defined as middle of two central subcarriers that the wake-up signal/channel may be mapped to. In an example of the embodiment, the location of the center may be defined with respect to the starting subcarrier of the starting PRB of the enclosing BWP. In another example, the location of the center may be defined with respect to the Common Resource Block (CRB) #0 or with respect to point-A for the DL carrier.

In one embodiment, the location of the wake-up signal/channel can be determined without the configuration of BWP. In one option, location of the center subcarrier of the wake-up signal/channel can be derived by a reference point and an offset. In another option, location of middle of two central subcarriers that the wake-up signal/channel may be mapped to can be derived by a reference point and an offset. In another option, location of first subcarrier of the smallest RB of wake-up signal/channel can be derived by a reference point and an offset. The reference point can be CRB #0 or point-A for the DL carrier or the starting PRB of a specific BWP, e.g., the initial BWP. The offset is associated with SCS for the wake-up signal/channel, or SCS for a SS/PBCH, or SCS for initial BWP, or configured reference SCS.

In one embodiment, multiple wake-up signals/channels occasions can be multiplexed in non-overlapped subcarriers/PRBs with non-zero overlap in time. A number of guard subcarriers/PRBs may be inserted between adjacent wake-up signals/channels to avoid the interference at WUR receiver.

In an example, guard frequency regions, in numbers of PRBs or subcarriers, may be configured between wake-up signal/channel and other NR physical signals/channels.

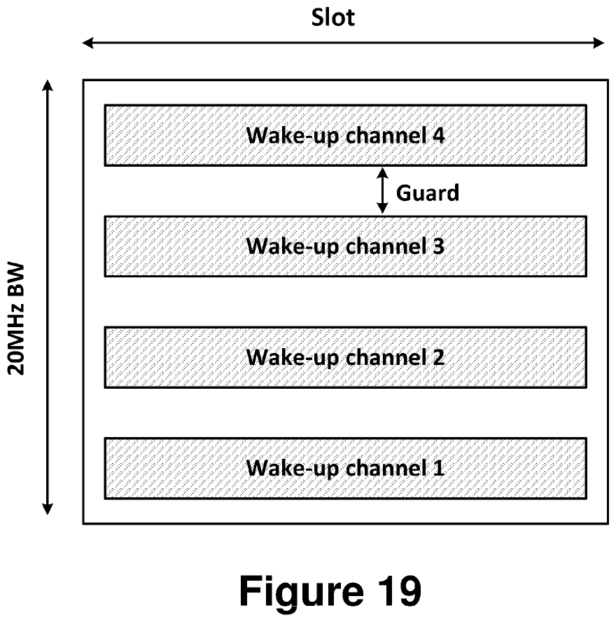

FIG. 19 illustrates one example for the multiplexing of wake-up signals/channels by FDM. The necessary number of the guard subcarriers/PRBs should be determined considering the non-ideal Rx filter at WUR receiver, so that the interference from adjacent wake-up channel is under control.

In one embodiment, when one or more wake-up signals/channels with guard bands are transmitted in a time, due to the presence of PRBs/subcarriers that are not carrying any signal, e.g., the guard band, gNB may perform power boosting for the wake-up signals/channels. The ratio of power boosting may be configured by SIB or dedicated high layer signaling. The ratio for power boosting may be up to gNB implementation. For example, gNB may maximize the power boosting based on current transmitted wake-up signals/channels in a time.

Specifically, a measurement based on the wake-up signal/channel may be defined, which can be used as a metric to check if the current cell is still valid for the UE. In such case, the transmission power for the wake-up signal/channel should be configured by SIB or dedicated high layer signaling.

In one embodiment, for the multiple wake-up signals/channels that are multiplexed by FDM in overlapped time, the sequence of the ON or OFF WUS symbols in the multiple wake-up signals/channels can be orthogonal or randomized. This is to avoid the ON symbols or OFF symbols of the multiple wake-up signals/channels always appear in the overlapped time. A wake-up signal/channel may include two parts. The first part could be a fixed sequence which may be used for AGC, rough time/frequency synchronization and indication on the presence of the second part. The second part may carry multiple bits for wake-up indication. The first part of multiple wake-up signals/channels may be overlapped in time.

In one option, a first wake-up signal/channel may use a sequence s for the WUS symbols in the first part, while the first part of a second wake-up signal/channel may use a complement sequence of s. That is, if the k_th element of sequence s is x, the k_th element of the complement sequence of s is 1-x.

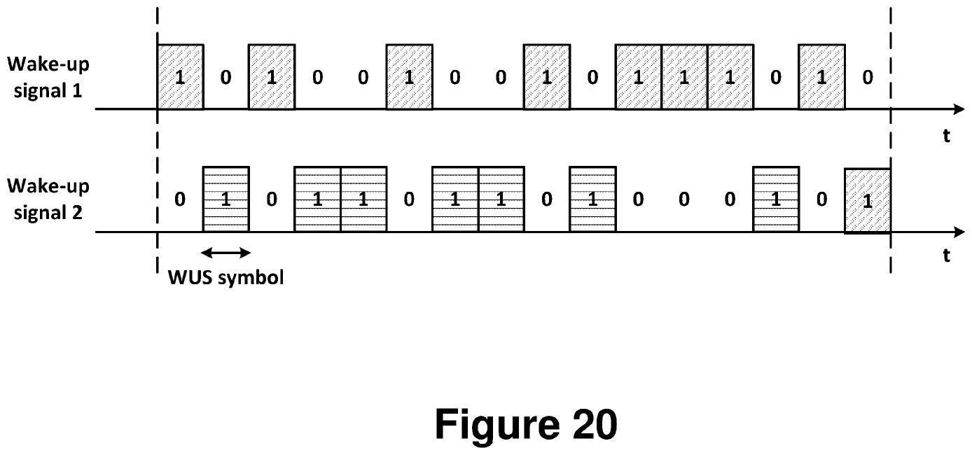

FIG. 20 illustrates one example for the first part of two FDMed wake-up signals/channels. Since the inverted sequences are used for the two wake-up signals/channels, gNB only transmits the ON symbol in one of the two channels. By this way, it can avoid the total transmission power exceeding the maximum transmission power when power boosting is applied to the first part.

In another option, multiple sequences for the first part of a wake-up signal/channel could be predefined. Correspondingly, the sequence of the first part of a wake-up signal/channel could be configured by high layer or implicitly determined by the other information. For example, the frequency of a wake-up signal/channel could be used to derive the sequence of the first part of the channel.

In another option, the sequence of the first part of a wake-up signal/channel could be generated by a pseudo random generator. For example, the generator could be a m-sequence or a gold sequence generator as defined in NR. In this option, the initial state of the generator could be predefined, or configured by high layer signaling, or determined by other information. For example, one or more parameters from the physical cell ID or a configured value to replace physical cell ID, UE ID, part or all of the SFN of a frame, part or all of the index of one or more of: the subframe, slot, OFDM symbol or WUS symbol may be used for the determination of the initial state. Note: the timing related parameters, SFN, the index of subframe, slot, OFDM symbol or WUS symbol may be defined in accordance with the overlapped frame, subframe, slot or OFDM symbol of the main receiver.

### Systems and Implementations

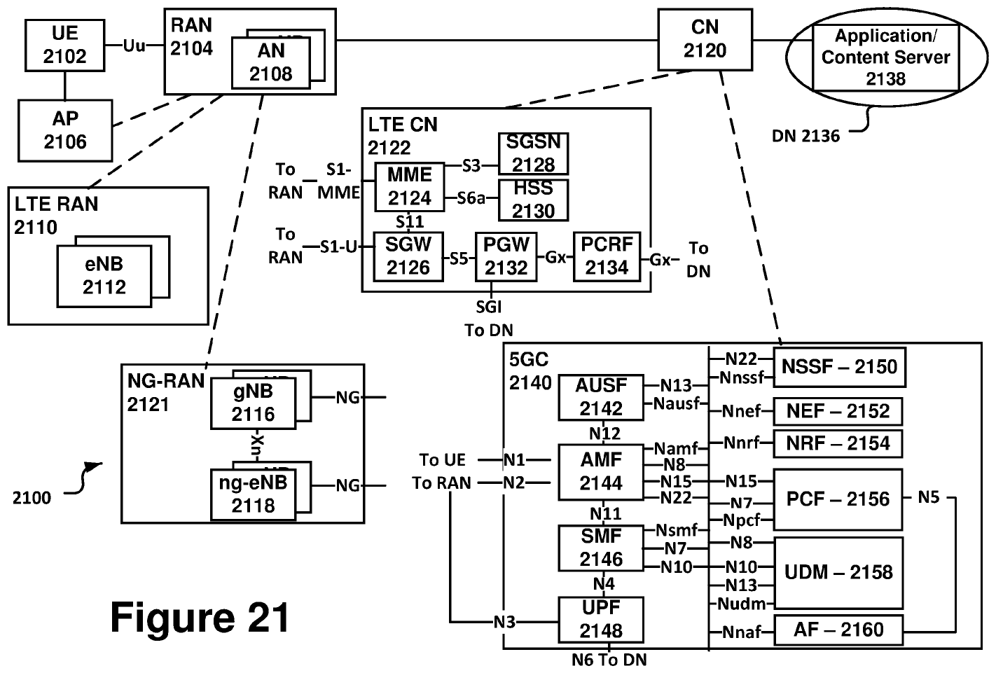

FIGS. 21-24 illustrate various systems, devices, and components that may implement aspects of disclosed embodiments.

FIG. 21 illustrates a network 2100 in accordance with various embodiments. The network 2100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 2100 may include a UE 2102, which may include any mobile or non-mobile computing device designed to communicate with a RAN 2104 via an over-the-air connection. The UE 2102 may be communicatively coupled with the RAN 2104 by a Uu interface. The UE 2102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 2100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 2102 may additionally communicate with an AP 2106 via an over-the-air connection. The AP 2106 may manage a WLAN connection, which may serve to offload some/all network traffic from the RAN 2104. The connection between the UE 2102 and the AP 2106 may be consistent with any IEEE 802.11 protocol, wherein the AP 2106 could be a wireless fidelity (Wi-Fi®) router. In some embodiments, the UE 2102, RAN 2104, and AP 2106 may utilize cellular-WLAN aggregation (for example, LWA/LWIP). Cellular-WLAN aggregation may involve the UE 2102 being configured by the RAN 2104 to utilize both cellular radio resources and WLAN resources.

The RAN 2104 may include one or more access nodes, for example, AN 2108. AN 2108 may terminate air-interface protocols for the UE 2102 by providing access stratum protocols including RRC, PDCP, RLC, MAC, and L1 protocols. In this manner, the AN 2108 may enable data/voice connectivity between CN 2120 and the UE 2102. In some embodiments, the AN 2108 may be implemented in a discrete device or as one or more software entities running on server computers as part of, for example, a virtual network, which may be referred to as a CRAN or virtual baseband unit pool. The AN 2108 be referred to as a BS, gNB, RAN node, eNB, ng-eNB, NodeB, RSU, TRxP, TRP, etc. The AN 2108 may be a macrocell base station or a low power base station for providing femtocells, picocells or other like cells having smaller coverage areas, smaller user capacity, or higher bandwidth compared to macrocells.

In embodiments in which the RAN 2104 includes a plurality of ANs, they may be coupled with one another via an X2 interface (if the RAN 2104 is an LTE RAN) or an Xn interface (if the RAN 2104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 2104 may each manage one or more cells, cell groups, component carriers, etc. to provide the UE 2102 with an air interface for network access. The UE 2102 may be simultaneously connected with a plurality of cells provided by the same or different ANs of the RAN 2104. For example, the UE 2102 and RAN 2104 may use carrier aggregation to allow the UE 2102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 2104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 2102 or AN 2108 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 2104 may be an LTE RAN 2110 with eNBs, for example, eNB 2112. The LTE RAN 2110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 2104 may be an NG-RAN 2114 with gNBs, for example, gNB 2116, or ng-eNBs, for example, ng-eNB 2118. The gNB 2116 may connect with 5G-enabled UEs using a 5G NR interface. The gNB 2116 may connect with a 5G core through an NG interface, which may include an N2 interface or an N3 interface. The ng-eNB 2118 may also connect with the 5G core through an NG interface, but may connect with a UE via an LTE air interface. The gNB 2116 and the ng-eNB 2118 may connect with each other over an Xn interface.

In some embodiments, the NG interface may be split into two parts, an NG user plane (NG-U) interface, which carries traffic data between the nodes of the NG-RAN 2114 and a UPF 2148 (e.g., N3 interface), and an NG control plane (NG-C) interface, which is a signaling interface between the nodes of the NG-RAN2114 and an AMF 2144 (e.g., N2 interface).

The NG-RAN 2114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 2102 can be configured with multiple BWPs where each BWP configuration has a different SCS. When a BWP change is indicated to the UE 2102, the SCS of the transmission is changed as well. Another use case example of BWP is related to power saving. In particular, multiple BWPs can be configured for the UE 2102 with different amount of frequency resources (for example, PRBs) to support data transmission under different traffic loading scenarios. A BWP containing a smaller number of PRBs can be used for data transmission with small traffic load while allowing power saving at the UE 2102 and in some cases at the gNB 2116. A BWP containing a larger number of PRBs can be used for scenarios with higher traffic load.

The RAN 2104 is communicatively coupled to CN 2120 that includes network elements to provide various functions to support data and telecommunications services to customers/subscribers (for example, users of UE 2102). The components of the CN 2120 may be implemented in one physical node or separate physical nodes. In some embodiments, NFV may be utilized to virtualize any or all of the functions provided by the network elements of the CN 2120 onto physical compute/storage resources in servers, switches, etc. A logical instantiation of the CN 2120 may be referred to as a network slice, and a logical instantiation of a portion of the CN 2120 may be referred to as a network sub-slice.

In some embodiments, the CN 2120 may be an LTE CN 2122, which may also be referred to as an EPC. The LTE CN 2122 may include MME 2124, SGW 2126, SGSN 2128, HSS 2130, PGW 2132, and PCRF 2134 coupled with one another over interfaces (or “reference points”) as shown. Functions of the elements of the LTE CN 2122 may be briefly introduced as follows.

The MME 2124 may implement mobility management functions to track a current location of the UE 2102 to facilitate paging, bearer activation/deactivation, handovers, gateway selection, authentication, etc.

The SGW 2126 may terminate an S1 interface toward the RAN and route data packets between the RAN and the LTE CN 2122. The SGW 2126 may be a local mobility anchor point for inter-RAN node handovers and also may provide an anchor for inter-3GPP mobility. Other responsibilities may include lawful intercept, charging, and some policy enforcement.

The SGSN 2128 may track a location of the UE 2102 and perform security functions and access control. In addition, the SGSN 2128 may perform inter-EPC node signaling for mobility between different RAT networks; PDN and S-GW selection as specified by MME 2124; MME selection for handovers; etc. The S3 reference point between the MME 2124 and the SGSN 2128 may enable user and bearer information exchange for inter-3GPP access network mobility in idle/active states.

The HSS 2130 may include a database for network users, including subscription-related information to support the network entities' handling of communication sessions. The HSS 2130 can provide support for routing/roaming, authentication, authorization, naming/addressing resolution, location dependencies, etc. An S6a reference point between the HSS 2130 and the MME 2124 may enable transfer of subscription and authentication data for authenticating/authorizing user access to the LTE CN 2120.

The PGW 2132 may terminate an SGi interface toward a data network (DN) 2136 that may include an application/content server 2138. The PGW 2132 may route data packets between the LTE CN 2122 and the data network 2136. The PGW 2132 may be coupled with the SGW 2126 by an S5 reference point to facilitate user plane tunneling and tunnel management. The PGW 2132 may further include a node for policy enforcement and charging data collection (for example, PCEF). Additionally, the SGi reference point between the PGW 2132 and the data network 2136 may be an operator external public, a private PDN, or an intra-operator packet data network, for example, for provision of IMS services. The PGW 2132 may be coupled with a PCRF 2134 via a Gx reference point.

The PCRF 2134 is the policy and charging control element of the LTE CN 2122. The PCRF 2134 may be communicatively coupled to the app/content server 2138 to determine appropriate QoS and charging parameters for service flows. The PCRF 2132 may provision associated rules into a PCEF (via Gx reference point) with appropriate TFT and QCI.

In some embodiments, the CN 2120 may be a 5GC 2140. The 5GC 2140 may include an AUSF 2142, AMF 2144, SMF 2146, UPF 2148, NSSF 2150, NEF 2152, NRF 2154, PCF 2156, UDM 2158, and AF 2160 coupled with one another over interfaces (or “reference points”) as shown. Functions of the elements of the 5GC 2140 may be briefly introduced as follows.

The AUSF 2142 may store data for authentication of UE 2102 and handle authentication-related functionality. The AUSF 2142 may facilitate a common authentication framework for various access types. In addition to communicating with other elements of the 5GC 2140 over reference points as shown, the AUSF 2142 may exhibit an Nausf service-based interface.

The AMF 2144 may allow other functions of the 5GC 2140 to communicate with the UE 2102 and the RAN 2104 and to subscribe to notifications about mobility events with respect to the UE 2102. The AMF 2144 may be responsible for registration management (for example, for registering UE 2102), connection management, reachability management, mobility management, lawful interception of AMF-related events, and access authentication and authorization. The AMF 2144 may provide transport for SM messages between the UE 2102 and the SMF 2146, and act as a transparent proxy for routing SM messages. AMF 2144 may also provide transport for SMS messages between UE 2102 and an SMSF. AMF 2144 may interact with the AUSF 2142 and the UE 2102 to perform various security anchor and context management functions. Furthermore, AMF 2144 may be a termination point of a RAN CP interface, which may include or be an N2 reference point between the RAN 2104 and the AMF 2144; and the AMF 2144 may be a termination point of NAS (N1) signaling, and perform NAS ciphering and integrity protection. AMF 2144 may also support NAS signaling with the UE 2102 over an N3 IWF interface.

The SMF 2146 may be responsible for SM (for example, session establishment, tunnel management between UPF 2148 and AN 2108); UE IP address allocation and management (including optional authorization); selection and control of UP function; configuring traffic steering at UPF 2148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 2144 over N2 to AN 2108; and determining SSC mode of a session. SM may refer to management of a PDU session, and a PDU session or “session” may refer to a PDU connectivity service that provides or enables the exchange of PDUs between the UE 2102 and the data network 2136.

The UPF 2148 may act as an anchor point for intra-RAT and inter-RAT mobility, an external PDU session point of interconnect to data network 2136, and a branching point to support multi-homed PDU session. The UPF 2148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 2148 may include an uplink classifier to support routing traffic flows to a data network.

The NSSF 2150 may select a set of network slice instances serving the UE 2102. The NSSF 2150 may also determine allowed NSSAI and the mapping to the subscribed S-NSSAIs, if needed. The NSSF 2150 may also determine the AMF set to be used to serve the UE 2102, or a list of candidate AMFs based on a suitable configuration and possibly by querying the NRF 2154. The selection of a set of network slice instances for the UE 2102 may be triggered by the AMF 2144 with which the UE 2102 is registered by interacting with the NSSF 2150, which may lead to a change of AMF. The NSSF 2150 may interact with the AMF 2144 via an N22 reference point; and may communicate with another NSSF in a visited network via an N31 reference point (not shown). Additionally, the NSSF 2150 may exhibit an Nnssf service-based interface.

The NEF 2152 may securely expose services and capabilities provided by 3GPP network functions for third party, internal exposure/re-exposure, AFs (e.g., AF 2160), edge computing or fog computing systems, etc. In such embodiments, the NEF 2152 may authenticate, authorize, or throttle the AFs. NEF 2152 may also translate information exchanged with the AF 2160 and information exchanged with internal network functions. For example, the NEF 2152 may translate between an AF-Service-Identifier and an internal 5GC information. NEF 2152 may also receive information from other NFs based on exposed capabilities of other NFs. This information may be stored at the NEF 2152 as structured data, or at a data storage NF using standardized interfaces. The stored information can then be re-exposed by the NEF 2152 to other NFs and AFs, or used for other purposes such as analytics. Additionally, the NEF 2152 may exhibit an Nnef service-based interface.

The NRF 2154 may support service discovery functions, receive NF discovery requests from NF instances, and provide the information of the discovered NF instances to the NF instances. NRF 2154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 2154 may exhibit the Nnrf service-based interface.

The PCF 2156 may provide policy rules to control plane functions to enforce them, and may also support unified policy framework to govern network behavior. The PCF 2156 may also implement a front end to access subscription information relevant for policy decisions in a UDR of the UDM 2158. In addition to communicating with functions over reference points as shown, the PCF 2156 exhibit an Npcf service-based interface.

The UDM 2158 may handle subscription-related information to support the network entities' handling of communication sessions, and may store subscription data of UE 2102. For example, subscription data may be communicated via an N8 reference point between the UDM 2158 and the AMF 2144. The UDM 2158 may include two parts, an application front end and a UDR. The UDR may store subscription data and policy data for the UDM 2158 and the PCF 2156, and/or structured data for exposure and application data (including PFDs for application detection, application request information for multiple UEs 2102) for the NEF 2152. The Nudr service-based interface may be exhibited by the UDR 221 to allow the UDM 2158, PCF 2156, and NEF 2152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 2158 may exhibit the Nudm service-based interface.

The AF 2160 may provide application influence on traffic routing, provide access to NEF, and interact with the policy framework for policy control.

In some embodiments, the 5GC 2140 may enable edge computing by selecting operator/3^{rd} party services to be geographically close to a point that the UE 2102 is attached to the network. This may reduce latency and load on the network. To provide edge-computing implementations, the 5GC 2140 may select a UPF 2148 close to the UE 2102 and execute traffic steering from the UPF 2148 to data network 2136 via the N6 interface. This may be based on the UE subscription data, UE location, and information provided by the AF 2160. In this way, the AF 2160 may influence UPF (re)selection and traffic routing. Based on operator deployment, when AF 2160 is considered to be a trusted entity, the network operator may permit AF 2160 to interact directly with relevant NFs. Additionally, the AF 2160 may exhibit an Naf service-based interface.

The data network 2136 may represent various network operator services, Internet access, or third party services that may be provided by one or more servers including, for example, application/content server 2138.

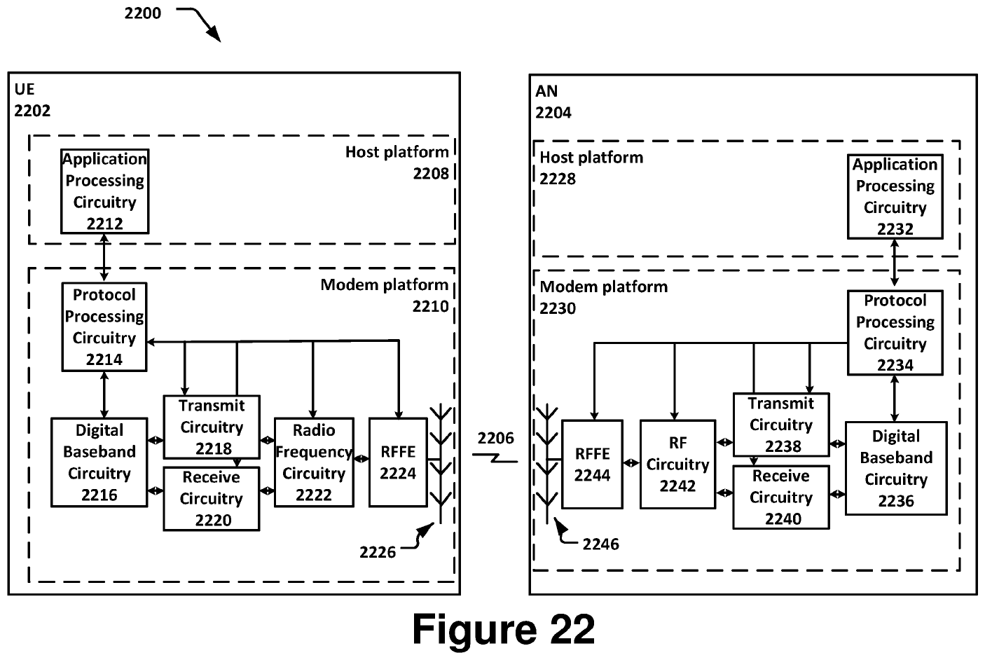

FIG. 22 schematically illustrates a wireless network 2200 in accordance with various embodiments. The wireless network 2200 may include a UE 2202 in wireless communication with an AN 2204. The UE 2202 and AN 2204 may be similar to, and substantially interchangeable with, like-named components described elsewhere herein.

The UE 2202 may be communicatively coupled with the AN 2204 via connection 2206. The connection 2206 is illustrated as an air interface to enable communicative coupling, and can be consistent with cellular communications protocols such as an LTE protocol or a 5G NR protocol operating at mmWave or sub-6 GHz frequencies.

The UE 2202 may include a host platform 2208 coupled with a modem platform 2210. The host platform 2208 may include application processing circuitry 2212, which may be coupled with protocol processing circuitry 2214 of the modem platform 2210. The application processing circuitry 2212 may run various applications for the UE 2202 that source/sink application data. The application processing circuitry 2212 may further implement one or more layer operations to transmit/receive application data to/from a data network. These layer operations may include transport (for example UDP) and Internet (for example, IP) operations

The protocol processing circuitry 2214 may implement one or more of layer operations to facilitate transmission or reception of data over the connection 2206. The layer operations implemented by the protocol processing circuitry 2214 may include, for example, MAC, RLC, PDCP, RRC and NAS operations.

The modem platform 2210 may further include digital baseband circuitry 2216 that may implement one or more layer operations that are “below” layer operations performed by the protocol processing circuitry 2214 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 2210 may further include transmit circuitry 2218, receive circuitry 2220, RF circuitry 2222, and RF front end (RFFE) 2224, which may include or connect to one or more antenna panels 2226. Briefly, the transmit circuitry 2218 may include a digital-to-analog converter, mixer, intermediate frequency (IF) components, etc.; the receive circuitry 2220 may include an analog-to-digital converter, mixer, IF components, etc.; the RF circuitry 2222 may include a low-noise amplifier, a power amplifier, power tracking components, etc.; RFFE 2224 may include filters (for example, surface/bulk acoustic wave filters), switches, antenna tuners, beamforming components (for example, phase-array antenna components), etc. The selection and arrangement of the components of the transmit circuitry 2218, receive circuitry 2220, RF circuitry 2222, RFFE 2224, and antenna panels 2226 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 2214 may include one or more instances of control circuitry (not shown) to provide control functions for the transmit/receive components.

A UE reception may be established by and via the antenna panels 2226, RFFE 2224, RF circuitry 2222, receive circuitry 2220, digital baseband circuitry 2216, and protocol processing circuitry 2214. In some embodiments, the antenna panels 2226 may receive a transmission from the AN 2204 by receive-beamforming signals received by a plurality of antennas/antenna elements of the one or more antenna panels 2226.

A UE transmission may be established by and via the protocol processing circuitry 2214, digital baseband circuitry 2216, transmit circuitry 2218, RF circuitry 2222, RFFE 2224, and antenna panels 2226. In some embodiments, the transmit components of the UE 2204 may apply a spatial filter to the data to be transmitted to form a transmit beam emitted by the antenna elements of the antenna panels 2226.

Similar to the UE 2202, the AN 2204 may include a host platform 2228 coupled with a modem platform 2230. The host platform 2228 may include application processing circuitry 2232 coupled with protocol processing circuitry 2234 of the modem platform 2230. The modem platform may further include digital baseband circuitry 2236, transmit circuitry 2238, receive circuitry 2240, RF circuitry 2242, RFFE circuitry 2244, and antenna panels 2246. The components of the AN 2204 may be similar to and substantially interchangeable with like-named components of the UE 2202. In addition to performing data transmission/reception as described above, the components of the AN 2208 may perform various logical functions that include, for example, RNC functions such as radio bearer management, uplink and downlink dynamic radio resource management, and data packet scheduling.

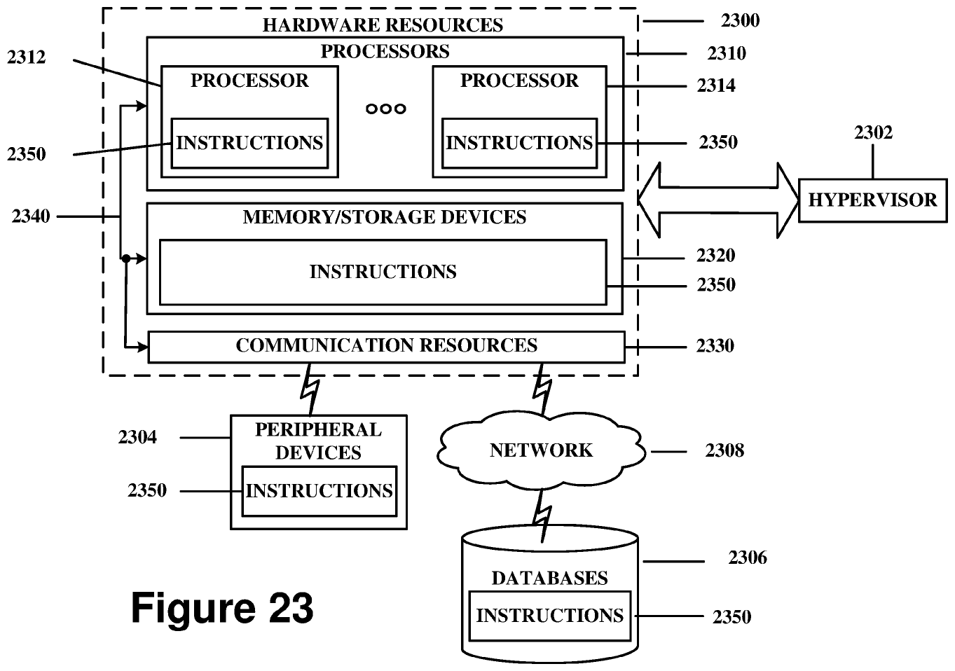

FIG. 23 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 23 shows a diagrammatic representation of hardware resources 2300 including one or more processors (or processor cores) 2310, one or more memory/storage devices 2320, and one or more communication resources 2330, each of which may be communicatively coupled via a bus 2340 or other interface circuitry. For embodiments where node virtualization (e.g., NFV) is utilized, a hypervisor 2302 may be executed to provide an execution environment for one or more network slices/sub-slices to utilize the hardware resources 2300.

The processors 2310 may include, for example, a processor 2312 and a processor 2314. The processors 2310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2320 may include main memory, disk storage, or any suitable combination thereof. The memory/storage devices 2320 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2330 may include interconnection or network interface controllers, components, or other suitable devices to communicate with one or more peripheral devices 2304 or one or more databases 2306 or other network elements via a network 2308. For example, the communication resources 2330 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2350 may comprise software, a program, an application, an applet, an app, or other executable code for causing at least any of the processors 2310 to perform any one or more of the methodologies discussed herein. The instructions 2350 may reside, completely or partially, within at least one of the processors 2310 (e.g., within the processor's cache memory), the memory/storage devices 2320, or any suitable combination thereof. Furthermore, any portion of the instructions 2350 may be transferred to the hardware resources 2300 from any combination of the peripheral devices 2304 or the databases 2306. Accordingly, the memory of processors 2310, the memory/storage devices 2320, the peripheral devices 2304, and the databases 2306 are examples of computer-readable and machine-readable media.

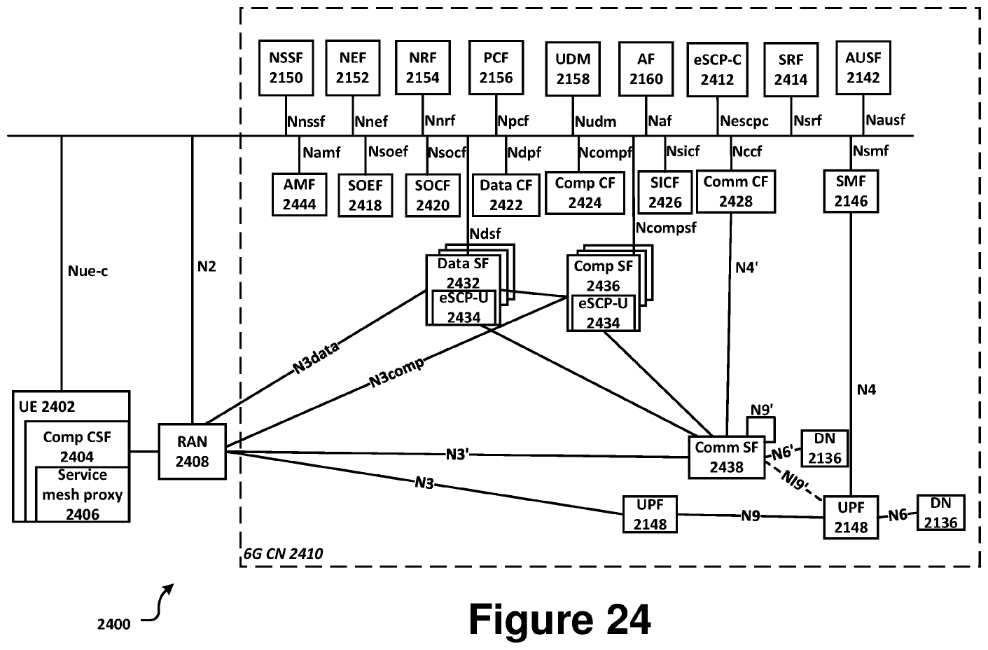

FIG. 24 illustrates a network 2400 in accordance with various embodiments. The network 2400 may operate in a matter consistent with 3GPP technical specifications or technical reports for 6G systems. In some embodiments, the network 2400 may operate concurrently with network 2100. For example, in some embodiments, the network 2400 may share one or more frequency or bandwidth resources with network 2100. As one specific example, a UE (e.g., UE 2402) may be configured to operate in both network 2400 and network 2100. Such configuration may be based on a UE including circuitry configured for communication with frequency and bandwidth resources of both networks 2100 and 2400. In general, several elements of network 2400 may share one or more characteristics with elements of network 2100. For the sake of brevity and clarity, such elements may not be repeated in the description of network 2400.

The network 2400 may include a UE 2402, which may include any mobile or non-mobile computing device designed to communicate with a RAN 2408 via an over-the-air connection. The UE 2402 may be similar to, for example, UE 2102. The UE 2402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 24, in some embodiments the network 2400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 24, the UE 2402 may be communicatively coupled with an AP such as AP 2106 as described with respect to FIG. 21. Additionally, although not specifically shown in FIG. 24, in some embodiments the RAN 2408 may include one or more ANss such as AN 2108 as described with respect to FIG. 21. The RAN 2408 and/or the AN of the RAN 2408 may be referred to as a base station (BS), a RAN node, or using some other term or name.

The UE 2402 and the RAN 2408 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 2408 may allow for communication between the UE 2402 and a 6G core network (CN) 2410. Specifically, the RAN 2408 may facilitate the transmission and reception of data between the UE 2402 and the 6G CN 2410. The 6G CN 2410 may include various functions such as NSSF 2150, NEF 2152, NRF 2154, PCF 2156, UDM 2158, AF 2160, SMF 2146, and AUSF 2142. The 6G CN 2410 may additional include UPF 2148 and DN 2136 as shown in FIG. 24.

Additionally, the RAN 2408 may include various additional functions that are in addition to, or alternative to, functions of a legacy cellular network such as a 4G or 5G network. Two such functions may include a Compute Control Function (Comp CF) 2424 and a Compute Service Function (Comp SF) 2436. The Comp CF 2424 and the Comp SF 2436 may be parts or functions of the Computing Service Plane. Comp CF 2424 may be a control plane function that provides functionalities such as management of the Comp SF 2436, computing task context generation and management (e.g., create, read, modify, delete), interaction with the underlaying computing infrastructure for computing resource management, etc. Comp SF 2436 may be a user plane function that serves as the gateway to interface computing service users (such as UE 2402) and computing nodes behind a Comp SF instance. Some functionalities of the Comp SF 2436 may include: parse computing service data received from users to compute tasks executable by computing nodes; hold service mesh ingress gateway or service API gateway; service and charging policies enforcement; performance monitoring and telemetry collection, etc. In some embodiments, a Comp SF 2436 instance may serve as the user plane gateway for a cluster of computing nodes. A Comp CF 2424 instance may control one or more Comp SF 2436 instances.

Two other such functions may include a Communication Control Function (Comm CF) 2428 and a Communication Service Function (Comm SF) 2438, which may be parts of the Communication Service Plane. The Comm CF 2428 may be the control plane function for managing the Comm SF 2438, communication sessions creation/configuration/releasing, and managing communication session context. The Comm SF 2438 may be a user plane function for data transport. Comm CF 2428 and Comm SF 2438 may be considered as upgrades of SMF 2146 and UPF 2148, which were described with respect to a 5G system in FIG. 21. The upgrades provided by the Comm CF 2428 and the Comm SF 2438 may enable service-aware transport. For legacy (e.g., 4G or 5G) data transport, SMF 2146 and UPF 2148 may still be used.

Two other such functions may include a Data Control Function (Data CF) 2422 and Data Service Function (Data SF) 2432 may be parts of the Data Service Plane. Data CF 2422 may be a control plane function and provides functionalities such as Data SF 2432 management, Data service creation/configuration/releasing, Data service context management, etc. Data SF 2432 may be a user plane function and serve as the gateway between data service users (such as UE 2402 and the various functions of the 6G CN 2410) and data service endpoints behind the gateway. Specific functionalities may include include: parse data service user data and forward to corresponding data service endpoints, generate charging data, report data service status.

Another such function may be the Service Orchestration and Chaining Function (SOCF) 2420, which may discover, orchestrate and chain up communication/computing/data services provided by functions in the network. Upon receiving service requests from users, SOCF 2420 may interact with one or more of Comp CF 2424, Comm CF 2428, and Data CF 2422 to identify Comp SF 2436, Comm SF 2438, and Data SF 2432 instances, configure service resources, and generate the service chain, which could contain multiple Comp SF 2436, Comm SF 2438, and Data SF 2432 instances and their associated computing endpoints. Workload processing and data movement may then be conducted within the generated service chain. The SOCF 2420 may also responsible for maintaining, updating, and releasing a created service chain.

Another such function may be the service registration function (SRF) 2414, which may act as a registry for system services provided in the user plane such as services provided by service endpoints behind Comp SF 2436 and Data SF 2432 gateways and services provided by the UE 2402. The SRF 2414 may be considered a counterpart of NRF 2154, which may act as the registry for network functions.

Other such functions may include an evolved service communication proxy (eSCP) and service infrastructure control function (SICF) 2426, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 2412 and eSCP-U 2434, for control plane service communication proxy and user plane service communication proxy, respectively. The SICF 2426 may control and configure eCSP instances in terms of service traffic routing policies, access rules, load balancing configurations, performance monitoring, etc.

Another such function is the AMF 2444. The AMF 2444 may be similar to 2144, but with additional functionality. Specifically, the AMF 2444 may include potential functional repartition, such as move the message forwarding functionality from the AMF 2444 to the RAN 2408.

Another such function is the service orchestration exposure function (SOEF) 2418. The SOEF may be configured to expose service orchestration and chaining services to external users such as applications.

The UE 2402 may include an additional function that is referred to as a computing client service function (comp CSF) 2404. The comp CSF 2404 may have both the control plane functionalities and user plane functionalities, and may interact with corresponding network side functions such as SOCF 2420, Comp CF 2424, Comp SF 2436, Data CF 2422, and/or Data SF 2432 for service discovery, request/response, compute task workload exchange, etc. The Comp CSF 2404 may also work with network side functions to decide on whether a computing task should be run on the UE 2402, the RAN 2408, and/or an element of the 6G CN 2410.

The UE 2402 and/or the Comp CSF 2404 may include a service mesh proxy 2406. The service mesh proxy 2406 may act as a proxy for service-to-service communication in the user plane. Capabilities of the service mesh proxy 2406 may include one or more of addressing, security, load balancing, etc.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLE PROCEDURES

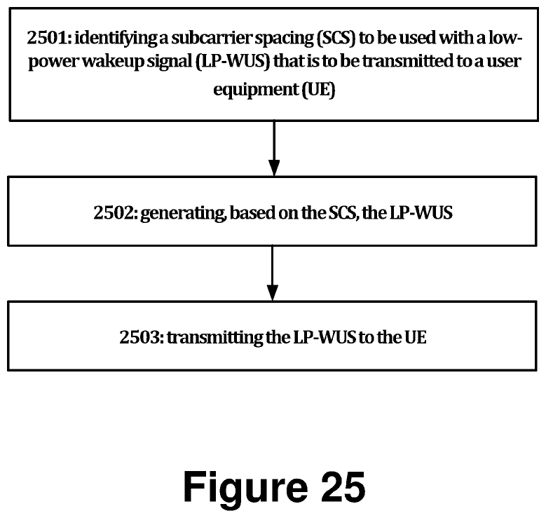

In some embodiments, the electronic device(s), network(s), system(s), chip(s) or component(s), or portions or implementations thereof, of FIGS. 21-24, or some other figure herein, may be configured to perform one or more processes, techniques, or methods as described herein, or portions thereof. One such process is depicted in FIG. 25. The process relates to a method to be performed by a base station, one or more elements of a base station, and/or an electronic device that includes or implements a base station. The process may include identifying, at 2501, a subcarrier spacing (SCS) to be used with a low-power wakeup signal (LP-WUS) that is to be transmitted to a user equipment (UE); generating, at 2502 based on the SCS, the LP-WUS; and transmitting, at 2503, the LP-WUS to the UE.

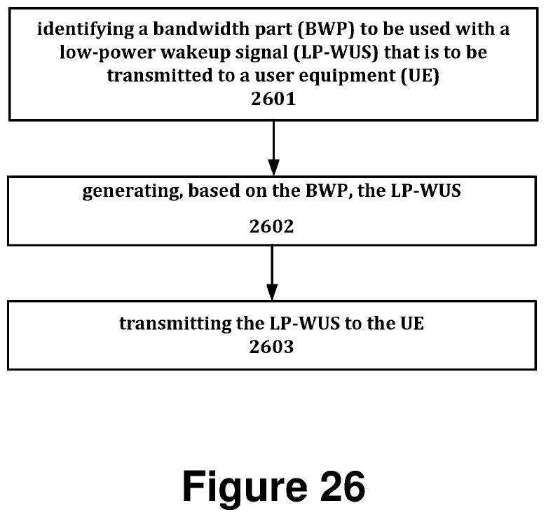

Another such process is depicted in FIG. 26. The process may relate to a method to be performed by a base station, one or more elements of a base station, one or more elements of a base station, and/or an electronic device that includes and/or implements a base station. The process may include identifying, at 2601, a bandwidth part (BWP) to be used with a low-power wakeup signal (LP-WUS) that is to be transmitted to a user equipment (UE); generating, at 2602 based on the BWP, the LP-WUS; and transmitting, at 2603, the LP-WUS to the UE.

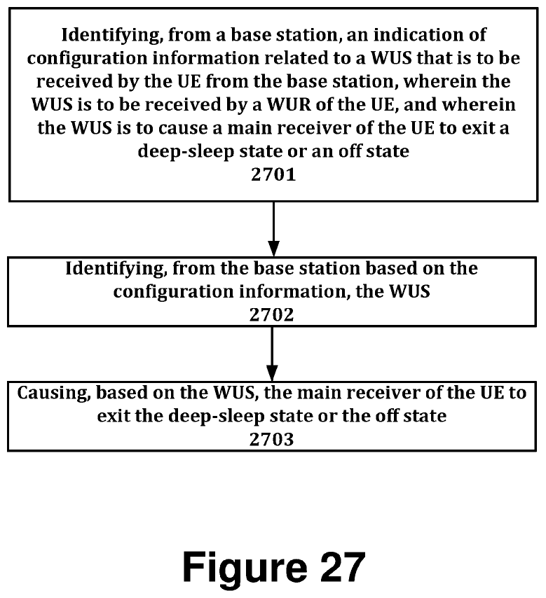

Another such process is depicted in FIG. 27. The process may relate to or include a method to be performed by a user equipment (UE), one or more elements of a UE, and/or one or more electronic devices that include and/or implement a UE. The process may include identifying, at 2701 from a base station, an indication of configuration information related to a wake-up signal (WUS) that is to be received by the UE from the base station, wherein the WUS is to be received by a wake-up receiver (WUR) of the UE, and wherein the WUS is to cause a main receiver of the UE to exit a deep-sleep state or an off state; identifying, at 2702 from the base station based on the configuration information, the WUS; and causing, at 2703 based on the WUS, the main receiver of the UE to exit the deep-sleep state or the off state.

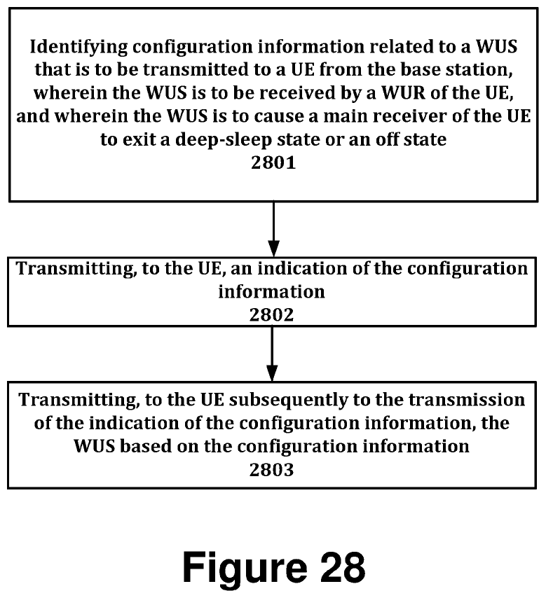

Another such process is depicted in FIG. 28. The process may relate to or include a method to be performed by a base station, one or more elements of a base station, and/or one or more electronic devices that include and/or implement a base station. The process may include identifying, at 2801, configuration information related to a wake-up signal (WUS) that is to be transmitted to a user equipment (UE) from the base station, wherein the WUS is to be received by a wake-up receiver (WUR) of the UE, and wherein the WUS is to cause a main receiver of the UE to exit a deep-sleep state or an off state; transmitting, at 2802 to the UE, an indication of the configuration information; and transmitting, at 2803 to the UE subsequently to the transmission of the indication of the configuration information, the WUS based on the configuration information

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1A may include a method for low power wake-up signal time, and/or frequency, and/or sequence resource determination.

Example 2A may include the method of example 1A and/or some other example herein, wherein at least one of time, frequency and sequence information for WUS is configured by gNB.

Example 3A may include the method of example 2A and/or some other example herein, wherein a set of at least one of time, frequency and sequence information for WUS is configured by gNB.

Example 4A may include the method of examples 2A and 3A and/or some other example herein, wherein the configuration can be carried by system information or UE specific higher-layer signaling.

Example 5A may include the method of example 1A and/or some other example herein, wherein at least one of time, frequency and sequence information for WUS is derived by specific ID.

Example 6A may include the method of example 5A and/or some other example herein, wherein the specific ID can be at least one of cell-specific ID, UE group ID, UE sub-group ID or UE ID.

Example 7A may include the method of examples 3A and 5A and/or some other example herein, wherein a set of at least one of time, frequency and sequence information for WUS is configured by gNB, and at least one of time, frequency and sequence information for WUS is derived based on the configured set and the specific ID.

Example 8A may include a method of a UE, the method comprising: receiving configuration information for a time, frequency, and/or sequence of a wake-up signal (WUS); and detecting, via a wake-up receiver, the WUS based on the configuration information.

Example 9A may include the method of example 8A and/or some other example herein, further comprising activating a main receiver based on the WUS Example 10A may include the method of example 8A-9A and/or some other example herein, wherein the configuration information is received via system information or UE specific higher-layer signaling.

Example 11A may include the method of example 8A-10A and/or some other example herein, wherein at least one of the time, frequency and sequence for the WUS is derived based on a specific ID.

Example 12A may include the method of example 8A-11A and/or some other example herein, wherein the specific ID corresponds to at least one of cell-specific ID, UE group ID, UE sub-group ID or UE ID.

Example 13A may include the method of example 11A-12A and/or some other example herein, wherein the WUS includes a first part and a second part, wherein the specific ID is included in the first part, and wherein the second part includes a payload of wake-up information and does not include the specific ID.

Example 14A may include the method of example 13A and/or some other example herein, wherein the specific ID corresponds to a physical cell ID, tracking area ID or RAN area ID.

Example 1B includes a method for low power wake-up signal design in a time domain.

Example 2B includes the method of example 1B and/or some other example(s) herein, wherein the wake-up signal/channel uses a same SCS numerology as an OFDM symbol of other control and/or data channels/signals of a UE.

Example 3B includes the method of example 2B and/or some other example(s) herein, wherein an OFDM symbol containing N WUS symbols is generated by pre-DFT processing.

Example 4B includes the method of example 2B or 3B and/or some other example(s) herein, wherein an OFDM symbol containing N WUS symbols is generated by transforming the targeted NFFT samples of the OFDM symbol to K subcarriers in frequency domain, then the K subcarriers are transformed back to time domain by IFFT operation.

Example 5B includes the method of examples 3B-4B and/or some other example(s) herein, wherein the cyclic prefix (CP) and cyclic postfix are added to make a fixed gap between the WUS symbols.

Example 6B includes the method of example 5B and/or some other example(s) herein, wherein, when the WUS symbols are to be mapped to two consecutive OFDM symbols of main radio, the CP or cyclic postfix can be respectively added to the first and second OFDM symbol.

Example 7B includes the method of example 1B and/or some other example(s) herein, wherein the wake-up signal/channel uses a different SCS numerology than at least one other channel/signal in the active BWP of a UE.

Example 8B includes the method of example 7B and/or some other example(s) herein, wherein the SCS for a WUS symbol is configurable.

Example 9B includes the method of example 7B or 8B and/or some other example(s) herein, wherein a WUS symbol with SCS y is mapped to a part of an OFDM symbol with SCS μₘ in NR.

Example 10B includes the method of example 9B and/or some other example(s) herein, wherein the duration of an OFDM symbol with CP is equally divided into multiple WUS symbols with CP.

Example 11B includes the method of example 9B or 10B and/or some other example(s) herein, wherein the duration of an OFDM symbol without CP is divided into multiple WUS symbols without CP.

Example 12B includes the method of examples 7B-11B and/or some other example(s) herein, wherein one or more consecutive subframes or slots are divided into multiple WUS symbols with same duration.

Example 13B includes the method of examples 7B-12B and/or some other example(s) herein, wherein each WUS symbol has equal CP length with remaining samples which are not allocated.

Example 14B includes the method of example 1B and/or some other example(s) herein, wherein the start of a wake-up signal/channel is defined relative to the start of a subframe or frame or slot.

Example 15B includes the method of examples 1B-14B and/or some other example(s) herein, wherein a wake-up signal/channel includes one part.

Example 16B includes the method of examples 1B-15B and/or some other example(s) herein, wherein a wake-up signal/channel includes at least two parts.

Example 17B includes a method to be performed by a radio access network (RAN) node, wherein the method comprises: identifying a subcarrier spacing (SCS) to be used with a low-power wakeup signal (LP-WUS) that is to be transmitted to a user equipment (UE); generating, based on the SCS, the LP-WUS; and transmitting the LP-WUS to the UE.

Example 18B includes the method of example 17B and/or some other example(s) herein, wherein the SCS is same or similar to an OFDM symbol of at least one other control channel of the UE or the RAN node or is same or similar to an OFDM symbol of at least one other data channel of the UE or the RAN node.

Example 19B includes the method of example 17B and/or some other example(s) herein, wherein the SCS is different than an OFDM symbol of at least one other control channel of the UE or the RAN node or is different than an OFDM symbol of at least one other data channel of the UE or the RAN node.

Example 20B includes the method of examples 17B-19B and/or some other example(s) herein, wherein the method includes: generating an OFDM symbol containing N LP-WUS symbols.

Example 21B includes the method of example 20B and/or some other example(s) herein, wherein the generating includes: generating the OFDM symbol by pre-DFT processing.

Example 22B includes the method of examples 20B-21B and/or some other example(s) herein, wherein the generating includes: generating the OFDM symbol by transforming a set of targeted NFFT samples of the OFDM symbol to K subcarriers in frequency domain,

Example 23B includes the method of example 22B and/or some other example(s) herein, wherein the method includes: transforming or causing transformation of the K subcarriers back to a time domain by IFFT operation.

Example 24B includes the method of examples 20B-23B and/or some other example(s) herein, wherein the method includes: adding a cyclic prefix and/or a cyclic postfix to be a fixed gap between one or more of the N LP-WUS symbols.

Example 25B includes the method of example 26B and/or some other example(s) herein, wherein the method includes: when the LP-WUS symbols are to be mapped to two consecutive OFDM symbols of a main radio, adding the cyclic prefix and/or the cyclic postfix to a first OFDM symbol of the two consecutive OFDM symbols and a second OFDM symbol of the two consecutive OFDM symbols, respectively.

Example 26B includes the method of examples 17B-25B and/or some other example(s) herein, wherein the LP-WUS uses a different SCS numerology than at least one other channel and/or signal in an active BWP of the UE or the RAN node.

Example 27B includes the method of example 26B and/or some other example(s) herein, wherein the SCS for a LP-WUS symbol is configurable.

Example 28B includes the method of example 26B or 27B and/or some other example(s) herein, wherein an LP-WUS symbol with SCS y is mapped to a part of an OFDM symbol with SCS μₘ in NR.

Example 29B includes the method of example 28B and/or some other example(s) herein, wherein the duration of an OFDM symbol with CP is equally divided into multiple LP-WUS symbols with cyclic prefix and/or a cyclic postfix.

Example 30B includes the method of example 28B or 29B and/or some other example(s) herein, wherein the duration of an OFDM symbol without CP is divided into multiple LP-WUS symbols without cyclic prefix and/or a cyclic postfix.

Example 31B includes the method of examples 26B-30B and/or some other example(s) herein, wherein one or more consecutive subframes or slots are divided into multiple LP-WUS symbols with a same duration.

Example 32B includes the method of examples 26B-31B and/or some other example(s) herein, wherein each LP-WUS symbol has an equal cyclic prefix and/or a cyclic postfix length with remaining samples which are not allocated.

Example 33B includes the method of examples 17B-32B and/or some other example(s) herein, wherein a start of the LP-WUS is defined relative to a start of a subframe or frame or slot.

Example 34B includes the method of any of examples 17B-33B and/or some other example(s) herein, wherein the LP-WUS includes one part.

Example 35B includes the method of any of examples 17B-34B and/or some other example(s) herein, wherein the LP-WUS includes two or more parts.

Example 1C may include the system and method for low power wake-up signal design in frequency domain.

Example 2C may include the system and method of example 1C and/or some other example herein, wherein a wake-up signal/channel for a UE is configured in the same initial or active BWP for other channels/signals of the UE

Example 3C may include the system and method of example 1C and/or some other example herein, wherein a wake-up signal/channel for a UE is configured in a BWP which is same or different from the initial or active BWP for other channels/signals of the UE

Example 4C may include the system and method of examples 2C or 3C and/or some other example herein, wherein the location of the wake-up signal/channel within a BWP is defined by the location of the center subcarrier of the wake-up signal/channel

Example 5C may include the system and method of example 1C and/or some other example herein, wherein the location of the wake-up signal/channel is determined without the configuration of BWP

Example 6C may include the system and method of example 1C and/or some other example herein, wherein multiple wake-up signals/channels occasions are multiplexed in non-overlapped subcarriers/PRBs with non-zero overlap in time

Example 7C may include the system and method of examples 2C-6C and/or some other example herein, power boosting is applied to the wake-up signals/channels

Example 8C may include the system and method of example 6C and/or some other example herein, wherein the sequence of the ON or OFF WUS symbols in the multiple wake-up signals/channels are orthogonal or randomized

Example 9C includes a method to be performed by a base station, one or more elements of a base station, and/or an electronic device that includes or implements a base station, wherein the method comprises: identifying a bandwidth part (BWP) to be used with a low-power wakeup signal (LP-WUS) that is to be transmitted to a user equipment (UE); generating, based on the BWP, the LP-WUS; and transmitting the LP-WUS to the UE.

Example 10C includes the method of example 9C, and/or some other example herein, wherein the BWP is similar to that of another channel or signal of the UE.

Example 11C includes the method of example 9C, and/or some other example herein, wherein the SCS is different than that of another channel or signal of the UE.

Example 12C includes the method of example 9C, and/or some other example herein, wherein the BWP is based on a location of a center subcarrier of the LP-WUS.

Example 13C includes the method of example 9C, and/or some other example herein, wherein the BWP is unrelated to a configuration of the LP-WUS.

Example 1D includes a method to be performed by a user equipment (UE), one or more elements of a UE, and/or one or more electronic devices that include and/or implement a UE, wherein the method comprises: identifying, from a base station, an indication of configuration information related to a wake-up signal (WUS) that is to be received by the UE from the base station, wherein the WUS is to be received by a wake-up receiver (WUR) of the UE, and wherein the WUS is to cause a main receiver of the UE to exit a deep-sleep state or an off state; identifying, from the base station based on the configuration information, the WUS; and causing, based on the WUS, the main receiver of the UE to exit the deep-sleep state or the off state.

Example 2D includes the method of example 1D, and/or some other example herein, wherein the main receiver of the UE, if in the deep-sleep state or the off state, is to remain in the deep-sleep state or the off state until receipt of the WUS.

Example 3D includes the method of example 1D, and/or some other example herein, wherein the WUS is based on ON-OFF Keying (OOK) or frequency shift keying (FSK).

Example 4D includes the method of any of examples 1D-3D, and/or some other example herein, wherein the configuration information relates to a time resource, a frequency resource, or a sequence of the WUS.

Example 5D includes the method of example 4D, and/or some other example herein, wherein the configuration information indicates a time resource of the WUS relative to a start of a subframe, frame, or slot in which the WUS will be transmitted.

Example 6D includes the method of example 4D, and/or some other example herein, wherein the configuration information indicates a frequency resource of the WUS within a bandwidth part (BWP) based on a center subcarrier of the WUS.

Example 7D includes the method of example 4D, and/or some other example herein, wherein the configuration information indicates a frequency resource of the WUS without reference to a bandwidth part (BWP) in which the WUS will be transmitted.

Example 8D includes the method of any of examples 1D-7D, and/or some other example herein, wherein a scrambling sequence is applied to a portion of the WUS, wherein the portion is less than the entire WUS.

Example 9D includes the method of any of examples 1D-8D, and/or some other example herein, wherein the WUR is configured to perform non-coherent detection of the WUS.

Example 10D includes the method of example 9D, and/or some other example herein, wherein the non-coherent detection is envelope detection.

Example 11D includes the method of any of examples 1D-10D, and/or some other example herein, wherein the WUS uses a same subcarrier spacing (SCS) numerology as an orthogonal frequency division multiplexed (OFDM) symbol of another channel or signal of the UE.

Example 12D includes the method of any of examples 1D-11D, and/or some other example herein, wherein the WUS is transmitted by the base station in an orthogonal frequency division multiplexed (OFDM) symbol that includes a plurality of WUS symbols.

Example 13D includes the method of example 12D, and/or some other example herein, wherein the OFDM symbol includes a temporal gap between consecutive WUS symbols of the plurality of WUS symbols.

Example 14D includes the method of example 13D, and/or some other example herein, wherein the temporal gap is based on a cyclic prefix (CP) or a cyclic postfix.

Example 15D includes the method of example 13D, and/or some other example herein, wherein the plurality of WUS symbols are evenly spaced in time throughout the OFDM symbol.

Example 16D includes the method of an of examples 1D-15D, and/or some other example herein, wherein the WUS is transmitted in a same initial or active bandwidth part (BWP) as other channels or signals transmitted to the UE from the base station.

Example 17D includes the method of any of examples 1D-16D, and/or some other example herein, wherein the WUS is transmitted in a bandwidth part (BWP) that is different than a BWP of other channels or signals transmitted to the UE from the base station.

Example 18D includes the method of any of examples 1D-17D, and/or some other example herein, wherein the WUS is transmitted with a power spectral density (PSD) greater than a power spectral density (PSD) with which the configuration information was transmitted.

Example 1E includes a method to be performed by a base station, one or more elements of a base station, and/or one or more electronic devices that include and/or implement a base station, wherein the method comprises: identifying configuration information related to a wake-up signal (WUS) that is to be transmitted to a user equipment (UE) from the base station, wherein the WUS is to be received by a wake-up receiver (WUR) of the UE, and wherein the WUS is to cause a main receiver of the UE to exit a deep-sleep state or an off state; transmitting, to the UE, an indication of the configuration information; and transmitting, to the UE subsequently to the transmission of the indication of the configuration information, the WUS based on the configuration information.

Example 2E includes the method of example 1E, and/or some other example herein, wherein the main receiver of the UE, if in the deep-sleep state or the off state, is to remain in the deep-sleep state or the off state until receipt of the WUS.

Example 3E includes the method of example 1E, and/or some other example herein, wherein the WUS is based on ON-OFF Keying (OOK) or frequency shift keying (FSK).

Example 4E includes the method of any of examples 1E-3E, and/or some other example herein, wherein the configuration information relates to a time resource, a frequency resource, or a sequence of the WUS.

Example 5E includes the method of example 4E, and/or some other example herein, wherein the configuration information indicates a time resource of the WUS relative to a start of a subframe, frame, or slot in which the WUS will be transmitted.

Example 6E includes the method of example 4E, and/or some other example herein, wherein the configuration information indicates a frequency resource of the WUS within a bandwidth part (BWP) based on a center subcarrier of the WUS.

Example 7E includes the method of example 4E, and/or some other example herein, wherein the configuration information indicates a frequency resource of the WUS without reference to a bandwidth part (BWP) in which the WUS will be transmitted.

Example 8E includes the method of any of examples 1E-7E, and/or some other example herein, wherein a scrambling sequence is applied to a portion of the WUS, wherein the portion is less than the entire WUS.

Example 9E includes the method of any of examples 1E-8E, and/or some other example herein, wherein the WUR is configured to perform non-coherent detection of the WUS.

Example 10E includes the method of example 9E, and/or some other example herein, wherein the non-coherent detection is envelope detection.

Example 11E includes the method of any of examples 1E-10E, and/or some other example herein, wherein the WUS uses a same subcarrier spacing (SCS) numerology as an orthogonal frequency division multiplexed (OFDM) symbol of another channel or signal of the UE.

Example 12E includes the method of any of examples 1E-11E, and/or some other example herein, wherein the WUS is transmitted by the base station in an orthogonal frequency division multiplexed (OFDM) symbol that includes a plurality of WUS symbols.

Example 13E includes the method of example 12E, and/or some other example herein, wherein the OFDM symbol includes a temporal gap between consecutive WUS symbols of the plurality of WUS symbols.

Example 14E includes the method of example 13E, and/or some other example herein, wherein the temporal gap is based on a cyclic prefix (CP) or a cyclic postfix.

Example 15E includes the method of example 12E, and/or some other example herein, wherein the plurality of WUS symbols are evenly spaced in time throughout the OFDM symbol.

Example 16E includes the method of any of examples 1E-15E, and/or some other example herein, wherein the WUS is transmitted in a same initial or active bandwidth part (BWP) as other channels or signals transmitted to the UE from the base station.

Example 17E includes the method of any of examples 1E-16E, and/or some other example herein, wherein the WUS is transmitted in a bandwidth part (BWP) that is different than a BWP of other channels or signals transmitted to the UE from the base station.

Example 18E includes the method of any of examples 1E-17E, and/or some other example herein, wherein the WUS is transmitted with a power spectral density (PSD) greater than a power spectral density (PSD) with which the configuration information was transmitted.

Example Z01 may include an apparatus comprising means to perform one or more elements of a method described in or related to any of examples 1A-18E, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1A-18E, or any other method or process described herein.

Example Z03 may include an apparatus comprising logic, modules, or circuitry to perform one or more elements of a method described in or related to any of examples 1A-18E, or any other method or process described herein.

Example Z04 may include a method, technique, or process as described in or related to any of examples 1A-18E, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1A-18E, or portions thereof.

Example Z06 may include a signal as described in or related to any of examples 1A-18E, or portions or parts thereof.

Example Z07 may include a datagram, packet, frame, segment, protocol data unit (PDU), or message as described in or related to any of examples 1A-18E, or portions or parts thereof, or otherwise described in the present disclosure.

Example Z08 may include a signal encoded with data as described in or related to any of examples 1A-18E, or portions or parts thereof, or otherwise described in the present disclosure.

Example Z09 may include a signal encoded with a datagram, packet, frame, segment, protocol data unit (PDU), or message as described in or related to any of examples 1A-18E, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1A-18E, or portions thereof.

Example Z11 may include a computer program comprising instructions, wherein execution of the program by a processing element is to cause the processing element to carry out the method, techniques, or process as described in or related to any of examples 1A-18E, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
ADRF Analytics Data Repository Function
AF Application Function
AM Acknowledged Mode
AMBRAggregate Maximum Bit Rate
AMF Access and Mobility Management Function
AN Access Network
AnLF Analytics Logical Function
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBD Candidate Beam Detection
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
MTLF Model Training Logical Functions
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWDAF Network Data Analytics Function
NWUSNarrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-25. (canceled)

26. An apparatus for use in a user equipment (UE), wherein the apparatus comprises:
a memory to:
store configuration information received from a base station, wherein the configuration information is related to a wake-up signal (WUS) that is to be received by the UE from the base station, wherein the WUS is to be received by a wake-up receiver (WUR) of the UE, and wherein the WUS is to cause a main receiver of the UE to exit a deep-sleep state or an off state; and
store the WUS, wherein the WUS is received from the base station based on the configuration information; and
one or more processors to cause, based on the WUS, the main receiver of the UE to exit the deep-sleep state or the off state.

27. The apparatus of claim 26, wherein the main receiver of the UE, if in the deep-sleep state or the off state, is to remain in the deep-sleep state or the off state until receipt of the WUS.

28. The apparatus of claim 26, wherein the WUS is based on ON-OFF Keying (OOK) or frequency shift keying (FSK).

29. The apparatus of claim 26, wherein the configuration information relates to a time resource, a frequency resource, or a sequence of the WUS.

30. The apparatus of claim 26, wherein a scrambling sequence is applied to a portion of the WUS, wherein the portion is less than the entire WUS.

31. The apparatus of claim 26, wherein the WUR is configured to perform non-coherent detection of the WUS.

32. The apparatus of claim 26, wherein the WUS uses a same subcarrier spacing (SCS) numerology as an orthogonal frequency division multiplexed (OFDM) symbol of another channel or signal of the UE.

33. The apparatus of claim 26, wherein the WUS is transmitted by the base station in an orthogonal frequency division multiplexed (OFDM) symbol that includes a plurality of WUS symbols.

34. The apparatus of claim 33, wherein the OFDM symbol includes a temporal gap between consecutive WUS symbols of the plurality of WUS symbols.

35. The apparatus of claim 33, wherein the plurality of WUS symbols are evenly spaced in time throughout the OFDM symbol.

36. The apparatus of claim 26, wherein the WUS is transmitted in a same initial or active bandwidth part (BWP) as other channels or signals transmitted to the UE from the base station.

37. The apparatus of claim 26, wherein the WUS is transmitted in a bandwidth part (BWP) that is different than a BWP of other channels or signals transmitted to the UE from the base station.

38. The apparatus of claim 26, wherein the WUS is transmitted with a power spectral density (PSD) greater than a power spectral density (PSD) with which the configuration information was transmitted.

39. One or more non-transitory computer-readable media comprising instructions that, upon execution of the instructions by one or more processors of a user equipment (UE), are to cause the UE to:
identify, from a base station, an indication of configuration information related to a wake-up signal (WUS) that is to be received by the UE from the base station, wherein the WUS is to be received by a wake-up receiver (WUR) of the UE, and wherein the WUS is to cause a main receiver of the UE to exit a deep-sleep state or an off state;
identify, from the base station based on the configuration information, the WUS; and
cause, based on the WUS, the main receiver of the UE to exit the deep-sleep state or the off state.

40. The one or more non-transitory computer-readable media of claim 39, wherein the configuration information relates to a time resource of the WUS.

41. The one or more non-transitory computer-readable media of claim 39, wherein the configuration information relates to a frequency resource of the WUS.

42. The one or more non-transitory computer-readable media of claim 39, wherein the configuration information relates to a sequence of the WUS.

43. One or more non-transitory computer-readable media comprising instructions that, upon execution of the instructions by one or more processors of a base station, are to cause the base station to:
identify configuration information related to a wake-up signal (WUS) that is to be transmitted to a user equipment (UE) from the base station, wherein the WUS is to be received by a wake-up receiver (WUR) of the UE, and wherein the WUS is to cause a main receiver of the UE to exit a deep-sleep state or an off state;
transmit, to the UE, an indication of the configuration information; and
transmit, to the UE subsequently to the transmission of the indication of the configuration information, the WUS based on the configuration information.

44. The one or more non-transitory computer-readable media of claim 43, wherein the main receiver of the UE, if in the deep-sleep state or the off state, is to remain in the deep-sleep state or the off state until receipt of the WUS.

45. The one or more non-transitory computer-readable media of claim 43, wherein the WUS is based on ON-OFF Keying (OOK) or frequency shift keying (FSK).
